(19) United States
(12) Patent Application Publication
(10) Pub. No.: US 2014/0006137 A1
(43) Pub. Date: Jan. 2, 2014

(54) Event Control Schedule Management

(71) Applicants: Roger Melen, Los Altos Hills, CA (US); Kunihiko Kumita, Seto-shi (JP)

(72) Inventors: Roger Melen, Los Altos Hills, CA (US); Kunihiko Kumita, Seto-shi (JP)

(73) Assignees: TOYOTA INFOTECHNOLOGY CENTER CO., LTD., Tokyo (JP); TOYOTA JIDOSHA KABUSHIKI KAISHA, Toyota-shi (JP)

(21) Appl. No.: 13/536,729

(22) Filed: Jun. 28, 2012

(51) Int. Cl. H02J 7/00; G06Q 30/02

(52) U.S. Cl. 705/14.35; 701/22

(57) ABSTRACT

A system and method for managing event control schedules is disclosed. The system includes a retrieval module, an estimation module, a plan module and a scheduling module. The retrieval module retrieves mobile system data associated with a mobile computer system and user profile data associated with a user of the mobile computer system. The estimation module estimates a synchronized start time of a future trip for the user based at least in part on one or more of the mobile system data and the user profile data. The plan module generates one or more provisioning plans for the mobile computer system based at least in part on the synchronized start time of the future trip and determines a preferred provisioning plan from the one or more provisioning plans. The scheduling module schedules to provision the mobile computer system based at least in part on the preferred provisioning plan.

### BACKGROUND

The specification relates to a control system. In particular, the specification relates to a system and method for managing event control schedules.

As more and more people favor for clean and sustainable energy, the usage of electric vehicles and/or hybrid electric vehicles grows dramatically. It's very likely that many future electric vehicles or hybrid electric vehicles will be used for commutation between home and work on a daily basis with occasionally side trips to other destinations such as a park, a grocery store, etc. More than half of these vehicles is estimated to travel less than 22 miles per day and used for less than one hour per day in total. In other words, on average these vehicles will be parked at least 23 hours a day at a parking lot or a home garage. These vehicles may be re-charged at any time during the 23 parking hours as long as the vehicles are always connected to a power source.

Electric power grid efficiency will be greatly increased if the charging of vehicles are controlled and optimized by a central control system. It is very desirable that the central control system may schedule the charging of the vehicles in a region according to the power usage in the region so that the local power supply is matched to the local power demands from business, residence, vehicle charging, etc.

### SUMMARY

The specification includes a system and method for managing event control schedules according to some examples. The system includes a retrieval module, an estimation module, a plan module and a scheduling module. The retrieval module retrieves mobile system data associated with a mobile computer system. The retrieval module retrieves user profile data associated with a user of the mobile computer system. The estimation module estimates a synchronized start time of a future trip for the user based at least in part on one or more of the mobile system data and the user profile data. The plan module generates one or more provisioning plans for the mobile computer system based at least in part on the start time of the future trip. The plan module determines a preferred provisioning plan from the one or more provisioning plans. The scheduling module schedules to provision the mobile computer system based at least in part on the preferred provisioning plan.

In one embodiment, a mobile computer system is one of a smart phone, a tablet computer, a television, an automobile, a bus, a bionic implant or any other mobile system with computer electronics.

In one embodiment, a provisioning plan includes data for scheduling supply to a mobile computer system. For example, a provisioning plan includes a provisioning completion time, a provisioning priority and a provisioning status for supplying one or more of the following prior to a future trip: energy to an electric vehicle propulsion battery; thermal energy to a heating system: cooling to a vehicle passenger compartment; streaming and/or storing digital content (e.g., music, videos, etc.) to a vehicle infotainment system; downloading and/or updating current digital map data; and streaming and/or storing any other passenger related data (e.g., a passenger's favorite restaurant list, a passenger's favorite TV shows, etc.).

### BRIEF DESCRIPTION OF THE DRAWINGS

The specification is illustrated by way of example, and not by way of limitation in the figures of the accompanying drawings in which like reference numerals are used to refer to similar elements.

FIG. 1 is a high-level block diagram illustrating a system for managing event control schedules according to one embodiment.

FIG. 2A is a block diagram illustrating a provision system according to one embodiment.

FIG. 2B is a block diagram illustrating a charging system according to one embodiment.

FIG. 3A is a block diagram illustrating a first storage device according to one embodiment.

FIG. 3B is a block diagram illustrating a second storage device according to one embodiment.

FIG. 4 is a flowchart illustrating a method for managing charging schedules for vehicles according to one embodiment.

FIGS. 5A and 5B are flowcharts illustrating a method for managing charging schedules for vehicles according to another embodiment.

FIG. 6 is a flowchart illustrating a method for providing charging services to vehicles according to one embodiment.

FIGS. 7A and 7B are flowcharts illustrating a method for providing charging services to vehicles according to another embodiment.

FIGS. 8A and 8B are flowcharts illustrating a method for managing event control schedules for a mobile computer system according to one embodiment.

FIGS. 9A and 9B are flowcharts illustrating a method for managing temperature control schedules for vehicles according to one embodiment.

FIG. 10 is a graphical representation of a user interface for providing one or more charging profiles to a user according to one embodiment.

### DETAILED DESCRIPTION

A system and method for managing event control schedules is described below. In the following description, for purposes of explanation, numerous specific details are set forth in order to provide a thorough understanding of the specification. It will be apparent, however, to one skilled in the art that the embodiments can be practiced without these specific details. In other instances, structures and devices are shown in block diagram form in order to avoid obscuring the specification. For example, the specification is described in one embodiment below with reference to user interfaces and particular hardware. However, the description applies to any type of computing device that can receive data and commands, and any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The specification also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, compact disc read-only memories (CD-ROMs), magnetic disks, read-only memories (ROMs), random access memories (RAMs), erasable programmable read-only memories (EPROMs), electrically erasable programmable read-only memories (EEPROMs), magnetic or optical cards, flash memories including universal serial bus (USB) keys with non-volatile memory or any type of media suitable for storing electronic instructions, each coupled to a computer system bus.

Some embodiments can take the form of an entirely hardware embodiment, an entirely software embodiment or an embodiment containing both hardware and software elements. A preferred embodiment is implemented in software, which includes but is not limited to firmware, resident software, microcode, etc.

Furthermore, some embodiments can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the various embodiments as described herein.

### System Overview

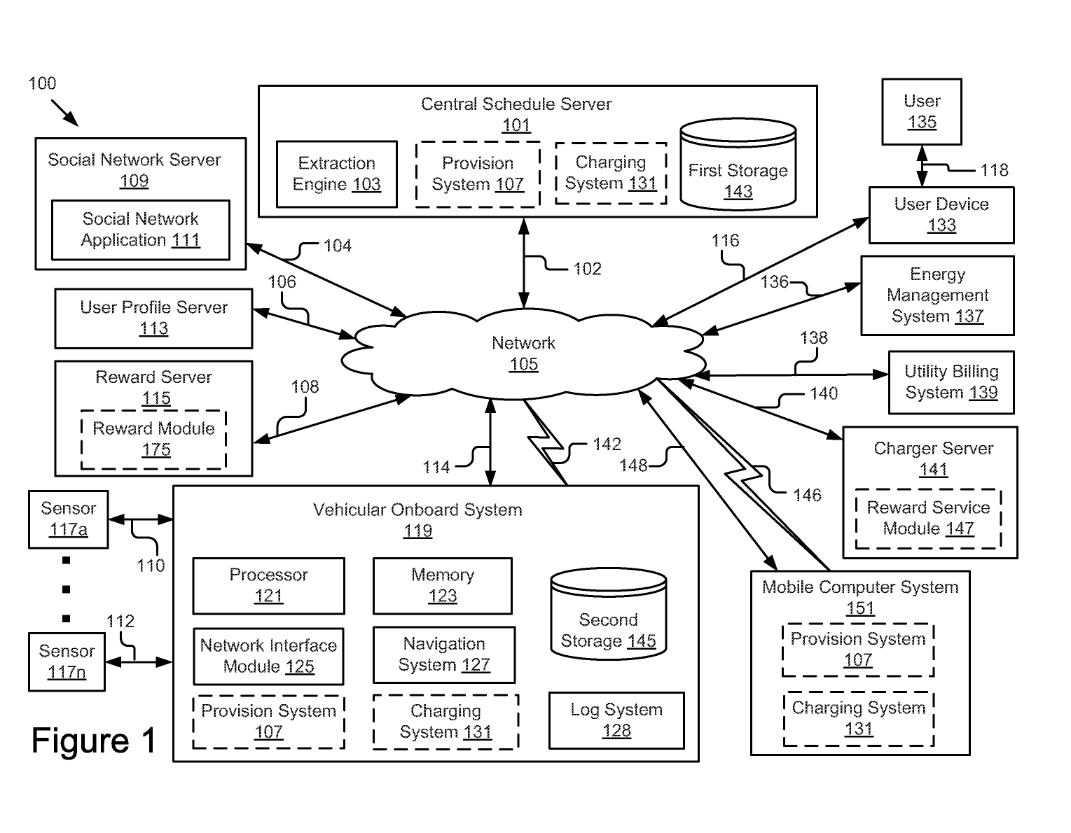

FIG. 1 illustrates a high-level block diagram of a system 100 for managing event control schedules according to one embodiment. The illustrated system 100 includes a central schedule server 101, a reward server 115, a vehicular onboard system 119, a mobile computer system 151 and a user device 133 that interacts with a user 135. Optionally, the system 100 also includes one or more of a social network server 109, a user profile server 113, an energy management system 137, a utility billing system 139 and a charger server 141.

Although only one central schedule server 101, one social network server 109, one user profile server 113, one reward server 115, one vehicular onboard system 119, one user device 133, one energy management system 137, one utility billing system 139, one charger server 141 and one mobile computer system 151 are depicted in FIG. 1, the system 100 could include any number of central schedule servers 101, social network servers 109, user profile servers 113, reward servers 115, vehicular onboard systems 119, user devices 133, energy management systems 137, utility billing systems 139, charger servers 141 and mobile computer systems 151. One skilled in the art will also appreciate that the system 100 may include other entities not shown in FIG. 1 such as a web server, a blog and/or micro-blog server, a video hosting server and a vehicle service server for providing traffic and/or weather information, etc.

In the illustrated embodiment, the entities of the system 100 are communicatively coupled via a network 105. For example, the central schedule server 101 is communicatively coupled to the network 105 via signal line 102. The social network server 109 is communicatively coupled to the network 105 via signal line 104. The user profile server 113 is communicatively coupled to the network 105 via signal line 106. The reward server 115 is communicatively coupled to the network 105 via signal line 108. The vehicular onboard system 119 is communicatively coupled to the network 105 via signal line 114. In one embodiment, the vehicular onboard system 119 is coupled to the network 105 via a wireless communication link 142. The user device 133 is communicatively coupled to the network 105 via signal line 116. The energy management system 137 is communicatively coupled to the network 105 via signal line 136. The utility billing system 139 is communicatively coupled to the network 105 via signal line 138. The charger server 141 is communicatively coupled to the network 105 via signal line 140. The mobile computer system 151 is communicatively coupled to the network 105 via signal line 148. In one embodiment, the mobile computer system 151 is coupled to the network 105 via a wireless communication link 146.

The network 105 is a conventional type of network, wired or wireless, and may have any number of configurations such as a star configuration, token ring configuration or other configurations known to those skilled in the art. In one embodiment, the network 105 comprises one or more of a local area network (LAN), a wide area network (WAN) (e.g., the Internet) and/or any other interconnected data path across which multiple devices communicate. In another embodiment, the network 105 is a peer-to-peer network. The network 105 is coupled to or includes portions of a telecommunications network for sending data in a variety of different communication protocols. For example, the network is a 3G network or a 4G network. In yet another embodiment, the network 105 includes Bluetooth communication networks or a cellular communications network for sending and receiving data such as via short messaging service (SMS), multimedia messaging service (MMS), hypertext transfer protocol (HTTP), direct data connection, wireless application protocol (WAP), email, etc. In yet another embodiment, all or some of the links in the network 105 are encrypted using conventional encryption technologies such as secure sockets layer (SSL), secure HTTP and/or virtual private networks (VPNs).

The central schedule server 101 is any computing device. For example, the central scheduling server 101 is a hardware server including a processor (not pictured), a memory (not pictured) and network communication capabilities. In the illustrated embodiment, the central schedule server 101 includes an extraction engine 103, a provision system 107, a charging system 131 and a first storage device 143. The components of the central schedule server 101 are communicatively coupled to each other.

In FIG. 1, the provision system 107 and the charging system 131 are depicted using dashed lines to indicate that, in some embodiments the provision system 107 and/or the charging system 131 are comprised within the central schedule server 101 while in other embodiments the provision system 107 and/or the charging system 131 are comprised within the vehicular onboard system 119 and/or the mobile computer system 151. In some embodiments, the provision system 107 and/or the charging system 131 can be stored in any combination of the devices and servers, or in only one of the devices or servers.

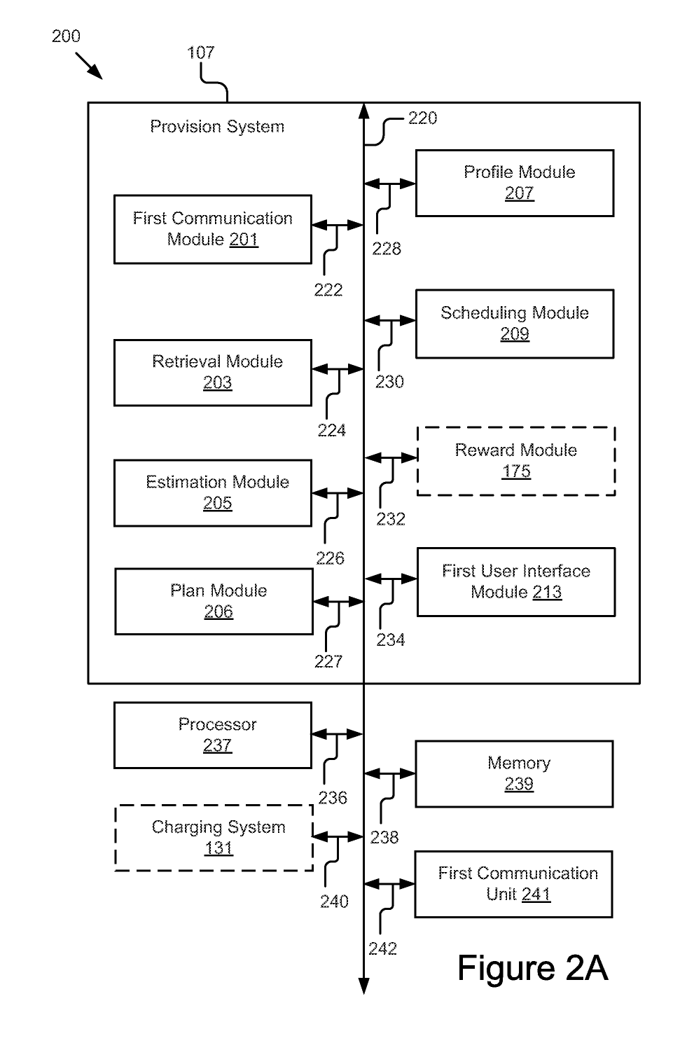

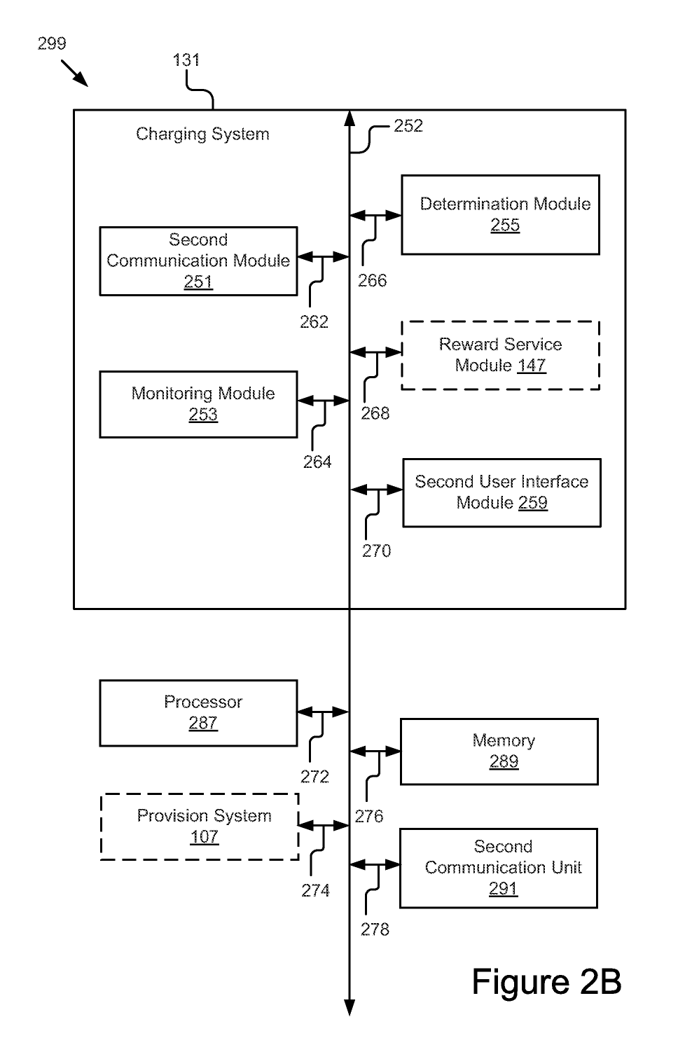

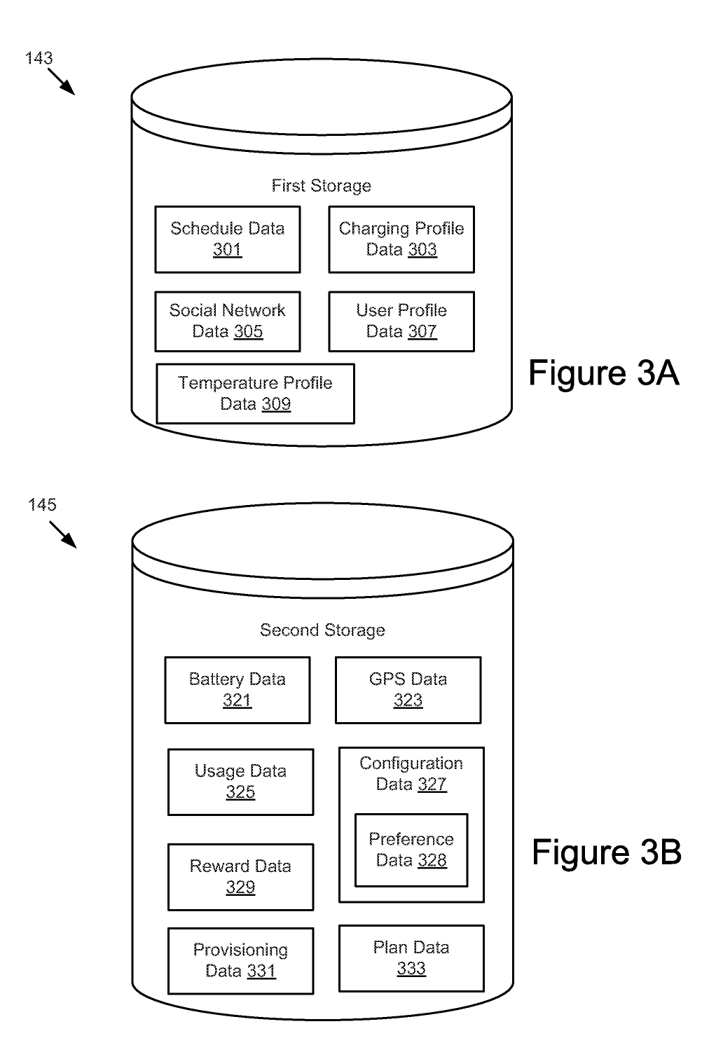

The extraction engine 103 is code and routines for extracting data from other entities of the system 100. For example, the extraction engine 103 extracts social network data associated with a user from the social network server 109, user profile data describing a profile of the user from the user profile server 113 and reward data associated with the user from the reward server 115. In one embodiment, the extraction engine 103 extracts vehicle data (e.g., vehicle usage data, location data, charging configuration data, etc.) and/or mobile system data (e.g., mobile system usage data, location data, provisioning configuration data, etc.) from one or more vehicular onboard systems 119 via the network 105. The social network data, the user profile data, the reward data, the vehicle data and the mobile system data are described below in more detail with reference to FIGS. 2A, 3A and 3B.

The extraction engine 103 sends one or more of the social network data, the user profile data, the reward data, the vehicle data and the mobile system data, etc., to the provision system 107. In one embodiment, the extraction engine 103 stores one or more of the social network data, the user profile data, the reward data, the vehicle data and the mobile system data, etc., in the first storage device 143 and/or the second storage 145.

The provision system 107 is code and routines for generating provisioning schedules. An event control schedule is a schedule to control the performing of an event. A provisioning schedule is an example of an event control schedule. A provisioning schedule is a schedule to provide provisioning services to a vehicle. For example, a provisioning schedule is a schedule for providing one or more of the following provisioning services prior to a future trip: warming vehicle seats; cooling liquids for a hybrid vehicle; controlling the air conditioning system; controlling the temperature for a passenger compartment in a vehicle; charging a battery in the vehicle; defrosting vehicle windows; uploading and/or downloading data related to the future trip to and/or from a server (e.g., map data, favorite cartoons for a kid taking the future trip, restaurants on the route, etc.); and/or controlling the engine temperature. In one embodiment, the provision system 107 uses a network at home or at work for cloud data uploads and/or downloads. For example, the provision system 107 transfers massive data between a vehicle and a server (e.g., a social network server 109, a web server, a video hosting server, etc.) using a network at home (e.g., a broadband network at home) when the vehicle is parking at a garage.

In one embodiment, a provisioning service includes controlling a temperature associated with a vehicle, and a provisioning schedule includes a temperature control schedule. A temperature control schedule is a schedule to control temperature in a vehicle. For example, a temperature control schedule is a heating control schedule to control the warming of vehicle seats, the heater of the vehicle and/or the warming of the engine prior to a trip, etc. In another example, a temperature control schedule is a cooling control schedule to control the air conditioning system and/or the cooling liquid of the vehicle, etc.

In another embodiment, a provisioning service also includes charging a vehicle, and a provisioning schedule includes a charging schedule for charging a vehicle (e.g., an electric vehicle, a hybrid electric vehicle, etc.). A charging schedule is a schedule to charge a vehicle. For example, a charging schedule indicates to begin charging a vehicle at 2:00 AM every day. In another example, a charging schedule indicates to complete charging a vehicle by 6:00 AM during weekdays.

In one embodiment, the provision system 107 includes code and routines for generating a charging schedule for a vehicle. In another embodiment, the provision system 107 includes a provisioning planning system that estimates a start time for a future trip. The provision system 107 automatically generates provisioning schedules to provide pre-trip provisioning services (e.g., engine system pre-trip temperature control, pre-trip battery check, fuel check for hybrid vehicles, passenger compartment temperature control, air conditioning system and/or heater control, etc.) to the vehicle based on the estimated start time of the future trip. For example, the provision system 107 includes code and routines for generating a temperature control schedule (e.g., a heating control schedule, a cooling control schedule, a window defrosting schedule, etc.) for a vehicle.

In yet another embodiment, the provision system 107 includes code and routines for planning a future trip. For example, the provision system 107 includes a journey planning system for estimating a future trip based at least in part on user profile data, historical trip data and/or route data. In another example, the provision system 107 includes a time planning system for estimating one or more of a trip start time, a trip end time and a trip duration, etc., for a future trip based at least in part on the user profile data, historical trip data and/or route data. In yet another example, the provision system 107 includes a content estimation system for estimating entertainment data such as favorite music, videos, TV shows, etc., for a driver or a passenger taking the future trip based at least in part on one or more of the user profile data, the social network data and the forum data. The provision system 107 streams the entertainment data to the vehicle using a network at home or at work (e.g., a wifi network) prior to the future trip while the vehicle is parking in a garage so that the entertainment data is ready to play when the future trip starts.

In one embodiment, the provision system 107 is implemented using hardware such as a field-programmable gate array (FPGA) or an application-specific integrated circuit (ASIC). In another embodiment, the provision system 107 is implemented using a combination of hardware and software. The provision system 107 is described below in more detail with reference to FIGS. 2A, 4-5B, 8A-8B and 9A-9B.

The charging system 131 is code and routines for providing charging services to a vehicle. In one embodiment, the charging system 131 provides an immediate charging service to a vehicle so that the vehicle is charged immediately. In another embodiment, the charging system 131 provides a reward charging service to a vehicle so that the vehicle is charged according to a charging schedule and rewarded according to a reward program. In one embodiment, the charging system 131 is implemented using hardware such as an FPGA or an ASIC. In another embodiment, the charging system 131 is implemented using a combination of hardware and software. The charging system 131 is described below in more detail with reference to FIGS. 2B and 6-7B.

The first storage device 143 is a non-transitory memory that stores data. For example, the first storage device 143 is a dynamic random access memory (DRAM) device, a static random access memory (SRAM) device, flash memory or some other memory device known in the art. In one embodiment, the first storage device 143 also includes a non-volatile memory or similar permanent storage device and media such as a hard disk drive, a floppy disk drive, a compact disc read only memory (CD-ROM) device, a digital versatile disc read only memory (DVD-ROM) device, a digital versatile disc random access memories (DVD-RAM) device, a digital versatile disc rewritable (DVD-RW) device, a flash memory device, or some other non-volatile storage device known in the art. The first storage device 143 is described below in more detail with reference to FIG. 3A.

The vehicular onboard system 119 is any processor-based computing device. For example, the vehicular onboard system 119 is an electronic control unit (“ECU”) implemented in a vehicle. In one embodiment, the vehicular onboard system 119 is implemented using a single integrated circuit such as a system-on-chip (SOC). The vehicular onboard system 119 includes a processor 121, a memory 123, a network interface module 125, a navigation system 127, a log system 128 and a second storage device 145. In some embodiments, the charging system 131 and/or the provision system 107 are also comprised within the vehicular onboard system 119. The components of the vehicular onboard system 119 are communicatively coupled to each other. In one embodiment, the vehicular onboard system 119 includes any other components conventional to an onboard system in a vehicle such as a dashboard, a display, a touch screen, an input device, etc.

The processor 121 comprises an arithmetic logic unit, a microprocessor, a general purpose controller or some other processor array to perform computations, retrieve data stored on the second storage device 145, etc. Processor 121 processes data signals and may comprise various computing architectures including a complex instruction set computer (CISC) architecture, a reduced instruction set computer (RISC) architecture, or an architecture implementing a combination of instruction sets. Although only a single processor 121 is shown in the vehicular onboard system 119, multiple processors may be included. The processing capability may be limited to supporting the display of images and the capture and transmission of images. The processing capability might be enough to perform more complex tasks, including various types of feature extraction and sampling. It will be obvious to one skilled in the art that other processors, operating systems, sensors, displays and physical configurations are possible.

The memory 123 stores instructions and/or data that may be executed by the processor 121. The instructions and/or data may comprise code for performing any and/or all of the techniques described herein. The memory 123 may be a dynamic random access memory (DRAM) device, a static random access memory (SRAM) device, flash memory or some other memory device known in the art. In one embodiment, the memory 123 also includes a non-volatile memory or similar permanent storage device and media such as a hard disk drive, a floppy disk drive, a CD-ROM device, a DVD-ROM device, a DVD-RAM device, a DVD-RW device, a flash memory device, or some other mass storage device known in the art for storing information on a more permanent basis.

The network interface module 125 is a device configured to connect the vehicular onboard system 119 to the network 105. For example, the network interface module 125 is a network adapter for wired communication with the network 105. In another example, the network interface module 125 is a wireless network adapter for wireless communication with the network 105.

In one embodiment, the network interface module 125 includes a port for direct physical connection to the network 105 or to another communication channel. For example, the network interface module 125 includes a universal serial bus (USB), category 5 cable (CAT-5) or similar port for wired communication with the network 105. In another embodiment, the network interface module 125 includes a wireless transceiver for exchanging data with the network 105, or with another communication channel, using one or more wireless communication methods, such as IEEE 802.11, IEEE 802.16, BLUETOOTH®, near field communication (NFC) or another suitable wireless communication method. In one embodiment, the network interface module 125 includes a NFC chip that generates a radio frequency (RF) for short-range communication. One having ordinary skill in the art will recognize that the network interface module 125 may include other types of devices for providing the functionality described herein.

The navigation system 127 is a system for providing navigation instructions. For example, the navigation system 127 is a global positioning system (GPS) for providing navigation instructions to a user. In one embodiment, the navigation system 127 generates location data describing a current location of a vehicle. In another embodiment, the navigation system 127 synchronizes the time in the vehicular onboard system 119 with a local time. In yet another embodiment, the navigation system 127 records routes and/or trips taken by the vehicle. The navigation system 127 sends one or more of the location data, the synchronized local time, route data and/or trip data to the log system 128.

The log system 128 is code and routines for recording data in the vehicular onboard system 119. In one embodiment, the log system 128 receives trip data describing a trip and/or route data describing a route from the navigation system 127 and stores the trip data and/or route data in the second storage device 145. For example, the log system 128 receives GPS data (e.g., current location, current local time, current route to a destination, trip duration, etc.) from a GPS system and stores the GPS data in the second storage device 145.

In one embodiment, the log system 128 retrieves social network data associated with a user from the social network server 109, user profile data of the user from the user profile server 113 and reward data for the vehicle from the reward server 115, and stores the received data in the second storage 145. In another embodiment, the log system 128 receives configuration data (e.g., charging configuration data, temperature configuration data or provisioning configuration data) from a user via a dashboard, a touch screen, or other input devices, and stores the configuration data in the second storage device 145. The configuration data is described below in more detail with reference to FIG. 3B. In other embodiments, the log system 128 may store any other data associated with a vehicle in the second storage 145.

The second storage device 145 is a non-transitory memory that stores data. For example, the second storage device 145 is a dynamic random access memory (DRAM) device, a static random access memory (SRAM) device, flash memory or some other memory device known in the art. In one embodiment, the second storage device 145 also includes a non-volatile memory or similar permanent storage device and media such as a hard disk drive, a floppy disk drive, a compact disc read only memory (CD-ROM) device, a digital versatile disc read only memory (DVD-ROM) device, a digital versatile disc random access memories (DVD-RAM) device, a digital versatile disc rewritable (DVD-RW) device, a flash memory device, or some other non-volatile storage device known in the art. The second storage device 145 is described below in more detail with reference to FIG. 3B.

One or more sensors 117a . . . 117n (referred to individually and collectively as sensor 117) are communicatively coupled to the vehicular onboard system 119. For example, the sensor 117a is communicatively coupled to the vehicular onboard system 119 via signal line 110. The sensor 117n is communicatively coupled to the vehicular onboard system 119 via signal line 112. The sensor 117 is any type of conventional sensor configured to collect any type of data. For example, the sensor 117 is one of the following: an infrared detector, a motion detector, a thermostat; and a sound detector, etc.

In one embodiment, the system 100 includes a combination of different types of sensors 117. For example, the system 100 includes different sensors 117 for measuring one or more of a time, a location of a vehicle (e.g., a latitude, longitude and altitude of the location), an acceleration of the vehicle, a velocity of the vehicle, a fuel tank level and/or a battery level, etc. The sensors 117 generate sensor data describing the one or more measurements and send the sensor data to the log system 128, causing the log system 128 to store the sensor data in the second storage device 145.

The user device 133 is any computing device that includes a memory and a processor, for example a laptop computer, a desktop computer, a tablet computer, a mobile telephone, a personal digital assistant (PDA), a mobile email device, a portable game player, a portable music player, a television with one or more processors embedded therein or coupled thereto or any other electronic device capable of accessing a network. The user 135 interacts with the user device 133 via signal line 118. The user 135 is a human user. In one embodiment, the user 135 is one of a driver and/or a passenger in a vehicle. In another embodiment, the user 135 is any user that has been authorized to access one or more of the central server 101, the mobile computer system 151 and the vehicular onboard system 119. The user 135 interacts with the user device 133, which sends and receives different types of data to and from one or more of the central schedule server 101, the social network server 109, the user profile server 113, the mobile computer system 151 and/or the vehicular onboard system 119.

The social network server 109 sends and receives data to and from one or more of the user device 133, the central schedule server 101, the mobile computer system 151 and the vehicular onboard system 119 via the network 105. For example, the social network server 109 is a hardware server. The social network server 109 also includes a social network application 111. A social network is any type of social structure where the users are connected by a common feature. The common feature includes relationships/connections, e.g., friendship, family, work, an interest, etc. The common features are provided by one or more social networking systems, such as those included in the architecture 100, including explicitly defined relationships and relationships implied by social connections with other online users, where the relationships form a social graph. In some examples, the social graph can reflect a mapping of these users and how they are related. Furthermore, it should be understood that the social network server 109 and the social network application 111 are representative of one social network and that there may be multiple social networks coupled to the network 105, each having its own server, application and social graph. For example, a first social network is more directed to business networking, a second is more directed to or centered on academics, a third is more directed to local business, a fourth is directed to dating and others are of general interest or a specific focus.

The user profile server 113 is any computing device. For example, the user profile server 113 is a hardware server including a processor, a memory and network communication capabilities. In one embodiment, the user 135 provides user profile data such as calendar data describing a personal calendar of the user 135, list data describing a to-do list, event data describing a preferred event list of the user 135 (e.g., a list of events such as a concert, a sport game, etc.) and demographic data associated with the user 135, etc., to the user profile server 113 via the network 105. The user profile server 113 stores the user profile data for the user 135 in a storage device (not pictured) comprised within the user profile server 113. The user profile server 113 provides the user profile data to one or more of the central schedule server 101, the mobile computer system 151 and the vehicular onboard system 119 responsive to a request for the user profile data from one or more of the central schedule server 101, the mobile computer system 151 and the vehicular onboard system 119.

The reward server 115 is any computing device. For example, the reward server 115 is a hardware server including a processor, a memory and network communication capabilities. Optionally, the reward server 115 includes a reward module 175. The reward module 175 is described below in more detail with reference to FIG. 2A. In one embodiment, the reward server 115 provides one or more reward programs to a user.

A reward program is a program that provides rewards to a participated user. In one embodiment, a reward program is a program that provides incentives to a user if the user agrees to charge a vehicle according to a charging schedule arranged by the central schedule server 101. For example, a reward program describes that if a user agrees to charge a vehicle during non-peak hours for power usage such as 1:00 AM-5:00 AM, the user will be charged at a promotion rate for the power usage. Examples of the incentives provided by the reward server 115 include, but not limited to, free charging for a vehicle when surplus power is available, a lower rate for power usage during non-peak hours and a high occupancy lane access privilege, etc.

The energy management system 137 is a system for managing power usage. For example, the energy management system 137 is a hardware server including a processor, a memory and network communication capabilities. In one embodiment, the energy management system 137 manages power usage for all the vehicles in a region such as a city, a state, etc. The energy management system 137 records a status (e.g., charging, not charging, charging complete, waiting for charging, etc.) for each vehicle connected to a power outlet either using a power cord or using a wireless channel.

In one embodiment, the energy management system 137 manages all the power usage in a region. For example, the energy management system 137 records the power usage for a power grid network in a region and generates power grid network data describing the power usage such as electric power usage for each hour in the region, average power usage per day and power usage during peak or non-peak hours, etc. In one embodiment, the energy management system 137 sends the power grid network data to one or more of the provision system 107 and the charging system 131.

In another embodiment, the energy management system 137 analyzes one or more of grid safety status for a location, the configuration of local utility distribution network and status data of current grid energy generation, etc. The energy management system 137 determines peak power demand in a region and monitors load balancing in the region. In other embodiments, the energy management system 137 may provide any other functionality described herein.

The utility billing system 139 is a system for managing billing data for power usage. For example, the utility billing system 139 is a hardware server including a processor, a memory and network communication capabilities. In one embodiment, the utility billing system 139 receives reward data associated with a user from one or more of the provision system 107 and the charging system 131, and generates billing data for the power usage based at least in part on the reward data. For example, if the reward data indicates that a user has charged a vehicle during non-peak hours, the utility billing system 139 bills the power usage used for charging the vehicle at a promotion rate (e.g., 50% off normal power rate).

The charger server 141 is a system for vehicle charging management. For example, the charger server 141 is a hardware server including a processor, a memory and network communication capabilities. Optionally, the charger server 141 includes a reward service module 147. The reward service module 147 is described below in more detail with reference to FIG. 2B. In one embodiment, the charger server 141 receives a charging schedule from a provision system 107 and configures charging parameters (e.g., a charger power level from 1 kW to 10 kW, a charging response time from 1 to 20 seconds, etc.) for charging a vehicle.

In one embodiment, the charger server 141 interacts with the energy management system 137 to receive data describing one or more of grid safety status in a location, configuration data for local utility distribution network, status data of current grid energy generation and power usage data in the location from the energy management system 137. The charger server 141 determines whether to charge one or more vehicles based on the received data. In one embodiment, the charger server 141 is a home charger server.

The mobile computer system 151 is any computing device that includes a memory and a processor, for example a laptop computer, a desktop computer, a tablet computer, a mobile telephone, a personal digital assistant (PDA), a mobile email device, a portable game player, a portable music player, a television with one or more processors embedded therein or coupled thereto or any other electronic device capable of accessing a network. In one embodiment, the mobile computer system 151 includes one or more of the provision system 107 and the charging system 131. In another embodiment, the vehicular onboard system 119 is considered as an example of a mobile computer system 151. In one embodiment, the mobile computer system 151 is a device for controlling a provisioning process such as a charging process, a temperature control process, etc., for a vehicle.

The system 100 is particularly beneficial in various respects. First, the system 100 automatically controls the charging of vehicles so that local power demand partially originated from the charging of vehicles is adapted to match to the local power supply. This balancing in the power usage control improves energy efficiency, reduces pollution and improves the operation of renewable energy sources.

Second, in addition to improving the efficiency of the power grid network, the system 100 also establishes a mechanism that meets individual charging requirements from each user by incorporating a charging profile (e.g., a charging completion time, a charging priority, etc.) into the scheduling of the charging. For example, a user may submit a charging profile to the system 100. Alternatively, the system 100 may automatically provide a charging profile to the user and the user may approve or modify the provided charging profile. Once a preferred charging profile is set up for the vehicle, the system 100 controls the charging of the vehicle further based on the preferred charging profile in order to address the individual charging requirements from the user.

Third, the system 100 provides rewards to encourage users to participate in the central charging control program. For example, if a user agrees to charge a vehicle according to a charging schedule provided by the system 100, the user is rewarded with a high occupancy lane access privilege. This is particularly appealing to users of hybrid vehicles because hybrid vehicles have alternative fuels.

Fourth, as described below in more detail, the system 100 estimates a start time for a future trip, which is not only used to estimate a charging completion time but also used to generate a provisioning completion time for providing provisioning services and/or a temperature control completion time for controlling the temperature in the vehicle. The system 100 is applicable to provide any provisioning service (e.g., a cooling service, a heating service, a charging service, etc.) to any vehicles.

### Provision System

Referring now to FIG. 2A, the provision system 107 is shown in more detail. FIG. 2A is a block diagram of a computing device 200 that includes a processor 237, a memory 239, a first communication unit 241 and a provision system 107 according to some examples. The components of the computing device 200 are communicatively coupled by a bus 220. Optionally, the computing device 200 also includes a charging system 131 which coupled to the bus 220 via signal line 240. In some embodiments, the computing device 200 is one of a central schedule server 101, a vehicular onboard system 119 and a mobile computer system 151.

The processor 237 has similar structure and provides similar functionality as the processor 121, and the description for the processor 237 will not be repeated here. In the depicted embodiment, the processor 237 is communicatively coupled to the bus 220 via signal line 236. The memory 239 has similar structure and provides similar functionality as the memory 123, and the description for the memory 239 will not be repeated here. In the depicted embodiment, the memory 239 is communicatively coupled to the bus 220 via signal line 238.

The first communication unit 241 transmits and receives data to and from at least one of the central schedule server 101, the mobile computer system 151 and the vehicular onboard system 119 depending upon where the provision system 107 is stored. The first communication unit 241 is coupled to the bus 220 via signal line 242. In one embodiment, the first communication unit 241 includes a port for direct physical connection to the network 105 or to another communication channel. For example, the first communication unit 241 includes a USB, SD, CAT-5 or similar port for wired communication with the user device 133. In another embodiment, the first communication unit 241 includes a wireless transceiver for exchanging data with the user device 133 or any other communication channel using one or more wireless communication methods, such as IEEE 802.11, IEEE 802.16, BLUETOOTH® or another suitable wireless communication method.

In yet another embodiment, the first communication unit 241 includes a cellular communications transceiver for sending and receiving data over a cellular communications network such as via short messaging service (SMS), multimedia messaging service (MMS), hypertext transfer protocol (HTTP), direct data connection, WAP, e-mail or another suitable type of electronic communication. In still another embodiment, the first communication unit 241 includes a wired port and a wireless transceiver. The first communication unit 241 also provides other conventional connections to the network for distribution of files and/or media objects using standard network protocols such as TCP/IP, HTTP, HTTPS and SMTP as will be understood to those skilled in the art.

In the illustrated embodiment, the provision system 107 includes a first communication module 201, a retrieval module 203, an estimation module 205, a plan module 206, a profile module 207, a scheduling module 209 and a first user interface module 213. Optionally, the provision system 107 includes a reward module 175. These components of the provision system 107 are communicatively coupled to the bus 220 for communication with each other.

The first communication module 201 is code and routines that, when executed by the processor 237, handles communications between components of the provision system 107 and other components of the computing device 200. In the illustrated embodiment, the first communication module 201 is communicatively coupled to the bus 220 via signal line 222. In one embodiment, the first communication module 201 receives one or more of social network data from the social network server 109 and user profile data from the user profile server 113, and sends the social network data and/or the user profile data to the retrieval module 203. In another embodiment, the first communication module 201 receives a charging profile and/or a temperature control profile from a user device 133 and sends the charging profile and/or the temperature control profile to the profile module 207. In yet another embodiment, the first communication module 201 receives a provisioning plan from a user device 133 and sends the provisioning plan to the plan module 206.

In one embodiment, the first communication module 201 receives graphical data for providing a user interface from the first user interface module 213 and sends the graphical data to a user device 133, causing the user device 133 to present the user interface to a user. The user interface depicts one or more charging profiles, temperature control profiles and/or provisioning plans. In some embodiments, the first communication module 201 may provide any other functionality for handling communications described herein.

The retrieval module 203 is code and routines that, when executed by the processor 237, retrieves data from one or more entities of the system 100. In the illustrated embodiment, the retrieval module 203 is communicatively coupled to the bus 220 via signal line 224. In one embodiment, the retrieval module 203 retrieves, via the first communication module 201, data from one or more of the social network server 109, the user profile server 113, the first storage 143 and/or the second storage 145. The retrieval module 203 sends the retrieved data to one or more of the estimation module 205, the plan module 206 and the profile module 207. For example, the retrieval module 203 retrieves social network data from the social network server 109, and sends the social network data to the estimation module 205. In one embodiment, the retrieval module 203 retrieves the social network data from the first storage 143.

In one embodiment, the retrieval module 203 retrieves user profile data from the user profile server 113 via the first communication module 201. The user profile data is data describing a profile of a user. For example, the user profile data includes one or more of calendar data describing a personal calendar of a user, list data describing a to-do list of the user, event data describing a preferred event list (e.g., a list including events such as a concert, a competition game, etc.), demographic data (e.g., gender, age, residence, education and/or working experience, etc.) and any other data associated with the user such as personal interests, hobbies, etc. In one embodiment, the retrieval module 203 retrieves the user profile data from the first storage 143.

In another embodiment, the retrieval module 203 retrieves battery data describing a power level of a battery in a vehicle and other vehicle data from the second storage 145. Vehicle data is data associated with a vehicle. For example, vehicle data includes one or more of charging configuration data for a vehicle, temperature configuration data for the vehicle, location data describing a current location of the vehicle, a synchronized local time and vehicle usage data describing historical usage of the vehicle (e.g., route data, trip data, etc.).

Charging configuration data is data for configuring the charging of a vehicle. For example, the charging configuration data includes one or more of preference data describing a charging preference, charging optimization metrics for optimizing the charging of a vehicle and reward participation data describing the reward programs that a vehicle or an owner of the vehicle participates in.

A charging preference is a preference to charge a vehicle. For example, a charging preference includes one or more of a charging schedule preference (e.g., always to charge a vehicle according to a charging schedule, only to charge a vehicle according to a charging schedule at weekends, always to charge a vehicle at non-peak hours, etc.) and a driver preference (e.g., a first driver prefers to charge the battery with 100% full, a second driver prefers to charge the battery with 80% full, etc.).

A charging optimization metric is a criterion for optimizing the charging of a vehicle. For example, a charging optimization metric is one of minimizing economic cost, maximizing rewards for the charging, satisfying a time constraint and/or charging a vehicle ecofriendly.

Temperature configuration data is data for configuring a temperature associated with a vehicle. For example, the temperature configuration data includes data for configuring a temperature of seats, engine, air conditioning system or cooling liquid, etc., in a vehicle prior to a trip.

In yet another embodiment, the retrieval module 203 retrieves mobile system data from the second storage 145. The mobile system data includes one or more of provisioning data, provisioning configuration data, location data describing a location of a mobile computer system 151, a synchronized local time, season data describing a current season, weather data describing the weather and usage data for a mobile computer system 151.

The provisioning data is data used for providing a provisioning service. For example, the provisioning data includes data (e.g., temperature data, fuel data, battery data, etc.) used for one or more of engine system pre-trip temperature control, pre-trip battery check, fuel check for hybrid vehicles, passenger compartment temperature control, air conditioning system and/or heater control, etc.

Provisioning configuration data is data for configuring a provisioning service. For example, the provisioning configuration data indicates to set a passenger compartment temperature to 50° F. prior to a start time of a future trip. In one embodiment, the provisioning configuration data includes the temperature configuration data and/or the charging configuration data.

In other embodiments, the retrieval module 203 retrieves data from any other servers. For example, the retrieval module 203 retrieves forum data associated with a user from a forum hosted by a web server (not pictured), blog data published by the user from a blog and/or micro-blog server (not pictured) and/or map data (e.g., driving direction data) from a map server (not pictured).

The estimation module 205 is code and routines that, when executed by the processor 237, estimates a future trip for a user. For example, the estimation module 205 estimates a start time of a future trip for a user. The estimation module 205 is communicatively coupled to the bus 220 via signal line 226. In one embodiment, the estimation module 205 receives one or more of social network data, user profile data and vehicle data from the retrieval module 203 and estimates a start time for a future trip based at least in part on the one or more of social network data, user profile data and vehicle data. The estimation module 205 sends the start time for the future trip to one or more of the plan module 206 and the profile module 207.

For example, if the vehicle data includes historic route data describing that the user usually takes a route from home to work at 8:00 AM during weekdays, the estimation module 205 determines a start time for a future trip to work as 8:00 AM in a weekday morning based on the historic route data. In another example, if the user profile data includes calendar data describing that the user has an early meeting at 8:30 AM in the next morning and the vehicle data includes route data describing that a driving time from home to work is less than 30 minutes, the estimation module 205 determines a start time for a future trip to work as a time before 8:00 AM such as 7:30 AM.

A start time for a future trip is a local time to start the future trip. In one embodiment, a start time for a future trip is adjusted based on a local time zone and synchronized with the Coordinated Universal Time (UTC) defined by International Telecommunications Union Recommendation (ITU-R TF.460-6) according to the local time zone via a network 105.

In some embodiments, the estimation module 205 estimates a start point, an end point, a trip duration and a trip path, etc., for the future trip based at least in part on the social network data, user profile data and/or vehicle data. In other embodiments, the estimation module 205 may estimate any other data associated with a future trip.

The plan module 206 is code and routines that, when executed by the processor 237, determines one or more provisioning plans for providing provisioning services. The plan module 206 is communicatively coupled to the bus 220 via signal line 227. A provisioning plan is a plan for providing a provisioning service. For example, a provisioning plan is a charging profile and/or a temperature control profile. The charging profile and the temperature control profile are described below in more detail. In one embodiment, a provisioning plan includes one or more of a provisioning completion time, a provisioning priority and a target provisioning status at the provisioning completion time.

A target provisioning status is a status to achieve when a provisioning service is completed. For example, a target provisioning status indicates a target temperature of 50° F. when a provisioning service for controlling temperature in a passenger compartment is completed prior to a future trip. A provisioning completion time is a time when a provisioning service is completed having a target provisioning status. For example, a provisioning completion time is 6:00 AM with a target temperature of 50° F. in a passenger compartment prior to a trip start time 6:30 AM. In one embodiment, a user does not request any specific provisioning completion time and the provisioning completion time is marked as “none” in the provisioning plan. A provisioning priority is data describing a priority to provide a provisioning service. For example, a provisioning priority is one of a “high” priority, a “medium” priority, a “low” priority and/or no priority requested.

In one embodiment, the plan module 206 receives provisioning configuration data (e.g., configuration data for setting one or more provisioning services, provisioning preference data, etc.) from the retrieval module 203. The plan module 206 receives a start time for a future trip from the estimation module 205. The plan module 206 determines one or more provisioning plans based at least in part on one or more of the provisioning configuration data and the start time for the future trip. For example, assume that the provisioning configuration data indicates to defrost vehicle windows prior to a morning trip. The estimated start time for the trip is 8:00 AM. The plan module 206 generates a provisioning plan having a provisioning completion time before the start time for the future trip such as 7:30 AM, a “high” provisioning priority and a target provisioning status of “window defrosted.”

The plan module 206 determines a preferred provisioning plan from the one or more provisioning plans. A preferred provisioning plan is a provisioning plan preferred by a user associated with a vehicle such as an owner or a driver of the vehicle. In one embodiment, the plan module 206 determines a preferred provisioning plan based at least in part on provisioning preference data describing a provisioning preference. For example, the plan module 206 selects a provisioning plan from the one or more provisioning plans that satisfies the provisioning preference as the preferred provisioning plan.

In one embodiment, the plan module 206 presents the one or more provisioning plans to a user and receives a response from the user. The plan module 206 determines the preferred provisioning plans based at least in part on the received response. For example, the plan module 206 instructs the first user interface module 213 to generate graphical data for providing a user interface depicting the one or more provisioning plans. The first user interface module 213 sends the graphical data to a user device 133, causing the user device 133 to present the user interface to a user. The user selects a provisioning plan from the one or more provisioning plans and sends a response including the selected provisioning plan to the plan module 206. The plan module 206 determines the selected provisioning plan as the preferred provisioning plan. In one embodiment, the user modifies a provisioning plan presented in the user interface and sends a response including the modified provisioning plan to the plan module 206. The plan module 206 determines the modified provisioning plan received from the user as the preferred provisioning plan.

In one embodiment, the plan module 206 sends the preferred provisioning plan to the scheduling module 209. In another embodiment, the plan module 206 stores the preferred provisioning plan in the first storage 143 and/or the second storage 145.

The profile module 207 is code and routines that, when executed by the processor 237, determines a charging profile and/or a temperature control profile for a vehicle. The profile module 207 is communicatively coupled to the bus 220 via signal line 228. In one embodiment, the profile module 207 is comprised within the plan module 206, and the plan module 206 is configured to perform part of or all of the functionality provided by the profile module 207. In one embodiment, a charging profile and a temperature control profile are examples of a provisioning plan generated by the plan module 206.

A charging profile is data used to generate a schedule for charging a vehicle. For example, the charging profile includes one or more of a charging completion time, a charging priority and a target power level (e.g., 80% full, 100% full of a battery, etc.) at the charging completion time. A charging completion time is a time when the charging of a vehicle is completed. For example, a charging completion time for a vehicle is 6:00 AM prior to a future trip starting at 7:00 AM. In one embodiment, a user does not request any specific charging completion time for a vehicle and the charging completion time is marked as “none” in the charging profile for the vehicle. A charging priority is data describing a priority to charge a vehicle. For example, a charging priority is one of a “high” priority, a “medium” priority, a “low” priority and/or no priority requested.

A temperature control profile is data used to generate a schedule for controlling a temperature associated with a vehicle. For example, the temperature control profile includes one or more of a temperature control completion time, a temperature control priority and a target temperature at the temperature control completion time. In one embodiment, a temperature control profile is a heating control profile for controlling the heating of a vehicle. In another embodiment, a temperature control profile is a cooling control profile for controlling the cooling of a vehicle.

A temperature control completion time is a time when the controlling of the temperature is completed. For example, a temperature control completion time for a vehicle is 6:00 AM prior to a future trip starting at 6:30 AM. A temperature control priority is data describing a priority to control the temperature of a vehicle. For example, a temperature control priority is one of a “high” priority, a “medium” priority, a “low” priority and/or no priority requested. A target temperature is a temperature to achieve at the temperature control completion time. For example, a target temperature is one of an engine temperature, a compartment temperature and a seat temperature, etc., to achieve at the temperature control completion time.

In one embodiment, the profile module 207 receives charging configuration data (e.g., reward participation data, charging optimization metrics, preference data, etc.) from the retrieval module 203. The profile module 207 also receives a start time for a future trip from the estimation module 205. The profile module 207 determines one or more charging profiles for the vehicle based at least in part on one or more of the charging configuration data and the start time for the future trip. For example, if a charging optimization metric indicates that minimizing economic cost is the only goal when charging a vehicle, the profile module 207 determines a charging profile for the vehicle having a charging completion time marked as “none” and a charging priority marked as “none” based on the charging optimization metric. In this case, the vehicle would be charged for free when there is surplus power in the power grid network.

In another example, assume that the reward participation data in the charging configuration data indicates that the vehicle is participated in a reward program which rewards the vehicle with a reduced power rate if the vehicle is charged with a “low” charging priority at non-peak hours. The estimated start time for the future trip is 6:00 AM. The profile module 207 determines a charging profile having a “low” charging priority and a charging completion time (such as 5:00 AM) at non-peak hours which is before the start time 6:00 AM of the future trip.

The profile module 207 determines a preferred charging profile from the one or more charging profiles. A preferred charging profile for a vehicle is a charging profile preferred by a user associated with the vehicle such as an owner or a driver of the vehicle. In one embodiment, the profile module 207 determines a preferred charging profile for the vehicle based at least in part on preference data describing a charging preference and/or one or more charging optimization metrics. For example, the profile module 207 selects a charging profile from the one or more charging profiles that satisfies the charging preference and/or the one or more charging optimization metrics as the preferred charging profile.

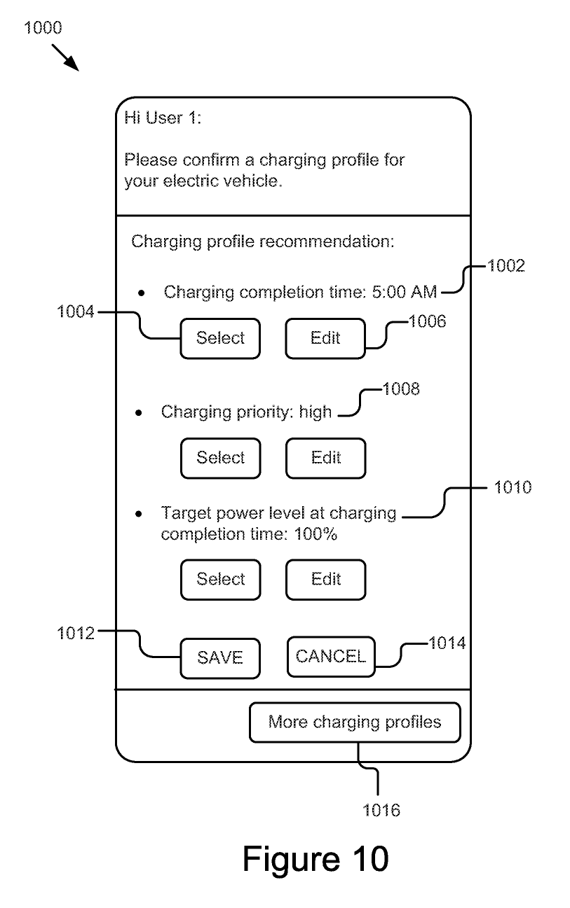

In one embodiment, the profile module 207 presents the one or more charging profiles to a user and receives a response from the user. The profile module 207 determines the preferred charging profile based at least in part on the received response. For example, the profile module 207 instructs the first user interface module 213 to generate graphical data for providing a user interface to the user. The first user interface module 213 sends the graphical data to a user device 133, causing the user device 133 to present the user interface to a user. The user interface depicts one or more charging profiles. An example of the user interface is shown in FIG. 10. The user selects a charging profile from the one or more charging profiles and sends a response including the selected charging profile to the profile module 207. The profile module 207 determines the preferred charging profile as the selected charging profile. In one embodiment, the user modifies a charging profile presented in the user interface and sends a response including the modified charging profile to the profile module 207. The profile module 207 determines the preferred charging profile as the modified charging profile received from the user.

In one embodiment, the profile module 207 sends the preferred charging profile to the scheduling module 209. In another embodiment, the profile module 207 stores the preferred charging profile in the first storage 143 and/or the second storage 145.

In one embodiment, the profile module 207 determines one or more temperature control profiles for a vehicle based at least in part on one or more of the temperature configuration data and a start time for a future trip. For example, assume that the temperature configuration data indicates to achieve a compartment temperature of 50° F. at least 15 minutes before a start time of a future trip. The start time of the future trip is 8:00 AM. The profile module 207 determines a temperature control profile including a temperature control completion time as 7:45 AM, a “high” temperature control priority and a target temperature for a compartment as 50° F.

The profile module 207 determines a preferred temperature control profile from the one or more temperature control profiles. A preferred temperature control profile is a temperature control profile preferred by a user. For example, the profile module 207 determines a preferred temperature control profile as a temperature control profile that satisfies a temperature control preference configured by a user. In another example, the profile module 207 presents the one or more temperature control profiles to a user and receives a response regarding the one or more temperature control profiles. In one embodiment, the response includes a temperature control profile selected by the user. In another embodiment, the response includes a temperature control profile modified by the user. The profile module 207 determines a preferred temperature control profile based at least in part on the received response. For example, the profile module 207 determines the preferred temperature control profile as the temperature control profile selected or modified by the user.

In one embodiment, the profile module 207 sends the preferred temperature control profile to the scheduling module 209. In another embodiment, the profile module 207 stores the preferred temperature control profile in the first storage 143 and/or the second storage 145.

The scheduling module 209 is code and routines that, when executed by the processor 237, generates a provisioning schedule for providing a provisioning service. The scheduling module 209 is communicatively coupled to the bus 220 via signal line 230. In one embodiment, the provisioning schedule includes one or more of a temperature control schedule and a charging schedule.

In one embodiment, the scheduling module 209 receives a preferred provisioning plan from the plan module 206, and determines a provisioning schedule based at least in part on the preferred provisioning plan. For example, if the preferred provisioning plan indicates that a provisioning completion time for defrosting the vehicle windows is 7:00 AM and it takes at least 5 minutes to complete defrosting, the scheduling module 209 generates a provisioning schedule including a start time for defrosting the vehicle windows as a time before 6:55 AM.

In another embodiment, the scheduling module 209 receives a preferred temperature control profile from the profile module 207. The scheduling module 209 determines a temperature control schedule based at least in part on the preferred temperature control profile. For example, if the preferred temperature control profile indicates that a temperature control completion time for warming vehicle seats is 7:00 AM and it takes at least 15 minutes to warm up the vehicle seats to a target temperature of 50° F., the scheduling module 209 generates a temperature control schedule including a start time for warming up the vehicle seats as a time before 6:45 AM such as 6:40 AM.

In yet another embodiment, the scheduling module 209 receives a preferred charging profile from the profile module 207 and schedules to charge the vehicle based at least in part on the preferred charging profile. For example, assume that a preferred charging profile indicates a “high” charging priority, a target power level of 100% full and a charging completion time of 6:00 AM. The scheduling module 209 receives battery data describing a current power level of a battery and determines a charging time duration (e.g., 1 hour) required to achieve the target power level of 100% full for the battery from the current power level. The scheduling module 209 determines a charging start time for a charging schedule as a time no later than the time difference between the charging completion time and the charging time duration (e.g., a charging start time such as 5:00 AM=a charging completion time such as 6:00 AM−a charging time duration such as 1 hour).

In one embodiment, the charging schedule includes a charging start time. The charging start time is a time to begin charging a vehicle. The scheduling module 209 sends the charging schedule to the charging system 131, causing the charging system 131 to charge the vehicle at the charging start time. In another embodiment, the charging schedule includes the charging completion time and a target power level. The scheduling module 209 sends the charging schedule to the charging system 131, causing the charging system 131 to complete charging the battery to the target power level by the charging completion time. In one embodiment, part of or all of the functionality provided by the scheduling module 209 is provided by the charging system 131. The charging system 131 is described below in more detail with reference to FIGS. 2B and 6-7B.

In one embodiment, a vehicle is charged more than once in order to achieve the target power level before the charging completion time. In other words, the charging schedule for the vehicle includes one or more charging start times and a charging duration for each charging start time. For example, assume that a requested charging completion time included in the preferred charging profile is 6:00 AM and it takes 1 hour to finish charging the battery. The scheduling module 209 generates a charging schedule that includes a first charging start time 3:00 AM with a first charging duration 30 minutes and a second charging start time 4:30 AM with a second charging duration 30 minutes. In this case, the charging of the vehicle will be completed at 5:00 AM which is before the requested charging completion time.

In one embodiment, the scheduling module 209 receives power grid network data describing power usage of a power grid network. The scheduling module 209 generates a charging schedule further based on the power grid network data. For example, even if the requested charging completion time is 6:00 AM and only 1 hour is required to complete charging the battery, the scheduling module 209 determines a charging start time for the charging schedule as 2:00 AM because the power grid network data indicates that the power grid network has surplus power from 2:00 AM to 3:00 AM.

In another embodiment, the scheduling module 209 controls power access for various vehicles by generating different charging schedules for different vehicles. For example, the scheduling module 209 generates a first charging schedule for a first vehicle and a second charging schedule for a second vehicle so that the first vehicle and the second vehicle are not charged at the same time. The scheduling module 209 balances power load in a power grid network by centrally controlling the charging of different vehicles so that the local power demand partially originated from the charging of local vehicles is configured to match to the instantaneous generated power capacity. For example, the scheduling module 209 generates charging schedules including non-peak hour charging start times so that the vehicles are charged during non-peak hours. In this case, the charging of vehicles will not add extra burden to the power grid network during power usage peak hours and may advantageously utilize surplus power during the non-peak hours.

This is particularly beneficial since, for example, this balancing in the power usage improves energy efficiency, reduces pollution, improves the operation of renewable energy sources and also provides rewards to vehicles that are charged according to the charging schedules generated by the scheduling module 209.

The reward module 175 is code and routines that, when executed by the processor 237, generates reward data for a vehicle. The reward module 175 is communicatively coupled to the bus 220 via signal line 232. In one embodiment, part of or all of the functionality provided by the reward module 175 is provided by a reward service module 147, which is described in more detail below with reference to FIG. 2B.

In one embodiment, the reward module 175 generates reward data for a mobile computer system 151 when charging a vehicle controlled by the mobile computer system 151 based on the preferred provisioning plan. For example, if the preferred provisioning plan includes a charging profile complying with a reward program, the reward module 175 generates reward data for the mobile computer system 151 if a vehicle controlled by the mobile computer system 151 is charged according to the charging profile.

In another embodiment, the reward module 175 receives a preferred charging profile from the profile module 207 and/or a charging schedule from the scheduling module 209. The reward module 175 generates reward data for a vehicle based at least in part on one or more of the preferred charging profile and the charging schedule. For example, if the vehicle is charged according to a charging schedule generated by the scheduling module 209, the reward module 175 generates reward data indicating a reduced power rate (e.g., 50% off normal price) for the power usage of charging the vehicle. In another example, the reward module 175 generates reward data indicating a high occupancy lane access privilege for a vehicle if the vehicle is configured to be charged always with a “low” charging priority.

In yet another embodiment, the reward module 175 receives a preferred temperature control profile from the profile module 207. The preferred temperature control profile additionally includes data describing a preferred charging profile for a vehicle. The reward module 175 generates reward data for the vehicle when charging the vehicle based at least in part on the preferred temperature control profile.

The first user interface module 213 is code and routines that, when executed by the processor 237, generates graphical data for providing user interfaces to a user. The first user interface module 213 sends the graphical data to a user device 133, causing the user device 133 to present the user interfaces to the user. In the illustrated embodiment, the first user interface module 213 is communicatively coupled to the bus 220 via signal line 234.

In one embodiment, the first user interface module 213 receives one or more charging profiles and/or temperature control profiles from the profile module 207 and generates graphical data for providing a user interface that depicts the one or more charging profiles and/or temperature control profiles. In another embodiment, the first user interface module 213 receives reward data from the reward module 175 and generates graphical data for providing a user interface that depicts the reward data. In yet another embodiment, the first user interface module 213 receives one or more provisioning plans from the plan module 206 and generates graphical data for providing a user interface that depicts the one or more provisioning plans. In other embodiments, the first user interface module 213 may generate graphical data for providing any other user interfaces to users.

### Charging System

Referring to FIG. 2B, the charging system 131 is described in more detail. FIG. 2B is a block diagram illustrating a computing device 299 according to one embodiment. In the illustrated embodiment, the computing device 299 includes a processor 287, a memory 289, a second communication unit 291 and a charging system 131. These components of the computing device 299 are communicatively coupled to each other via a bus 252. Optionally, the computing device 299 includes a provision system 107 that is communicatively coupled to the bus 252 via signal line 274. In one embodiment, the computing device 299 is one of a central schedule server 101, a vehicular onboard system 119 and a mobile computer system 151.

The processor 287 has similar structure and provides similar functionality as the processor 121, and the description for the processor 287 will not be repeated here. In the depicted embodiment, the processor 287 is communicatively coupled to the bus 252 via signal line 272. The memory 289 has similar structure and provides similar functionality as the memory 123, and the description for the memory 289 will not be repeated here. In the depicted embodiment, the memory 289 is communicatively coupled to the bus 252 via signal line 276. The second communication unit 291 has similar structure and provides similar functionality as the first communication unit 241, and the description for the second communication unit 291 will not be repeated here. The second communication unit 291 is communicatively coupled to the bus 252 via signal line 278.

In the illustrated embodiment, the charging system 131 includes a second communication module 251, a monitoring module 253, a determination module 255 and a second user interface module 259. Optionally, the charging system 131 includes a reward service module 147. These components of the charging system 131 are communicatively coupled by the bus 252.

The second communication module 251 is code and routines that, when executed by the processor 287, handles communications between the charging system 131 and other components of the computing device 299. The second communication module 251 is communicatively coupled to the bus 252 via signal line 262. In one embodiment, the second communication module 251 receives a charging request from a vehicle and sends the charging request to the monitoring module 253. In another embodiment, the second communication module 251 receives a charging profile and/or a charging schedule from the provision system 107 and sends the charging profile and/or the charging schedule to the determination module 255. In other embodiments, the second communication module 251 may handle any other communications for providing the functionality described herein.

The monitoring module 253 is code and routines that, when executed by the processor 287, monitors for any charging activities associated with a vehicle. The monitoring module 253 is communicatively coupled to the bus 252 via signal line 264. In one embodiment, the monitoring module 253 monitors for charging activities. Examples of a charging activity include, but not limited to, turning on a charger, connecting a vehicle to a power outlet using a power cord and connecting a vehicle wirelessly to a charger, etc. In one embodiment, the vehicle is charged using a power cord connected to a power outlet. In another embodiment, the vehicle is charged wirelessly.

The monitoring module 253 determines whether any charging request is received from a vehicle. For example, the monitoring module 253 determines whether a charger for the vehicle is turned on. In another example, the monitoring module 253 determines whether a charger for a vehicle is connected to a power outlet. If a charging request is received from a vehicle, the monitoring module 253 sends the charging request to the determination module 255.

The determination module 255 is code and routines that, when executed by the processor 287, determines a charging service for a vehicle. The determination module 255 is communicatively coupled to the bus 252 via signal line 266. In one embodiment, a charging service is one of an immediate charging service and a reward charging service. An immediate charging service is a charging service that charges a vehicle immediately. A reward charging service is a charging service that charges a vehicle according to a charging schedule and rewards the vehicle with one or more incentives. In one embodiment, a reward charging service is a charging service provided according to a reward program. For example, a reward charging service indicates to charge a vehicle in non-peak hours such as from 1:00 AM to 5:00 AM with a “low” charging priority so that reward data for a high occupancy lane access privilege is generated for the vehicle.

In one embodiment, the determination module 255 receives a charging request associated with a vehicle from the monitoring module 253 and determines whether a charging profile is established for the vehicle. For example, the determination module 255 determines whether a preferred charging profile is stored for the vehicle. If the charging profile is not established, the determination module 255 determines to provide an immediate charging service to the vehicle and sends an immediate charging signal to the reward service module 147, causing the reward service module 147 to provide the immediate charging service to the vehicle.

In one embodiment, if the charging profile is not established, the determination module 255 instructs the second user interface module 259 to generate graphical data for providing a user interface to a user. The user interface depicts one or more charging profiles. The second user interface module 259 sends the graphical data to a user device 133 and/or a dashboard (not pictured) in the vehicle, causing the user device 133 and/or the dashboard to present the user interface to the user. The user establishes a preferred charging profile for the vehicle via the user interface. The determination module 255 stores the preferred charging profile received from the user in the first storage 143.

If the charging profile is established, the determination module 255 retrieves the charging profile from the first storage 143. The determination module 255 determines whether a charging completion time is requested by the charging profile. For example, the determination module 255 determines whether the charging completion time is marked as “none.” If the charging completion time is marked as “none,” the determination module 255 determines to provide a reward charging service to the vehicle and sends a reward charging signal to the reward service module 147.

If a charging completion time is required by the charging profile, the determination module 255 determines whether any reward charging service fulfills the requested charging completion time. For example, the determination module 255 determines whether any reward charging service is able to complete the charging of the vehicle by the requested charging completion time. In a further example, assume that a reward charging service requires to charge a vehicle in non-peak hours between 2:00 AM and 5:00 AM to receive rewards. If the requested charging completion time is 1:00 AM, the determination module 255 determines that the reward charging service cannot fulfill the requested charging completion time. However, if the requested charging completion time is 6:00 AM, the determination module 255 determines that the reward charging service is able to fulfill the requested charging completion time.

In one embodiment, the determination module 255 retrieves power grid network data describing power usage from the energy management system 137. The determination module 255 determines whether any reward charging service fulfills the requested charging completion time further based on the power grid network data. For example, in view of the power usage described by the power grid network data (e.g., surplus power available, power shortage, power outage, etc.), the determination module 255 determines whether any reward charging service is able to finish the charging of a vehicle by the requested charging completion time. In a further example, assume that a reward charging service requires to charge a vehicle between 2:00 AM and 5:00 AM. The requested charging completion time is 6:00 AM. If the power grid network data indicates a power outage between 1:00 AM and 6:00 AM, the determination module 255 determines that the reward charging service is not able to fulfill the requested charging completion time.

If none of the reward charging services satisfies the requested charging completion time, the determination module 255 determines to provide the immediate charging service to the vehicle and sends an immediate charging signal to the reward service module 147. If at least one reward charging service satisfies the requested charging completion time, the determination module 255 determines to provide the at least one reward charging service to the vehicle and sends a reward charging signal to the reward service module 147. Optionally, the determination module 255 further determines whether the at least one reward charging service satisfies a charging priority in the charging profile. If the at least one reward charging service satisfies the charging priority, the determination module 255 determines to provide the at least one reward charging service to the vehicle. Otherwise, the determination module 255 determines to provide the immediate charging service to the vehicle.

The reward service module 147 is code and routines that, when executed by the processor 287, provides a reward charging service to a vehicle. The reward service module 147 is communicatively coupled to the bus 252 via signal line 268. In one embodiment, the reward service module 147 receives an immediate charging signal from the determination module 255 and provides the immediate charging service to the vehicle. For example, the reward service module 147 charges the vehicle immediately responsive to receiving the immediate charging signal.

In another embodiment, the reward service module 147 receives a reward charging signal from the determination module 255. The reward service module 147 provides a reward charging service to the vehicle responsive to receiving the reward charging signal. For example, if the reward charging service indicates to charge a vehicle between 2:00 AM and 5:00 AM and the requested charging completion time for the vehicle is 5:00 AM, the reward service module 147 charges the vehicle at 2:00 AM responsive to receiving the reward charging signal. In one embodiment, the reward service module 147 generates reward data for the vehicle when the reward charging service is provided to the vehicle.

The second user interface module 259 is code and routines that, when executed by the processor 287, generates graphical data for providing user interfaces to users. The second user interface module 259 is communicatively coupled to the bus 252 via signal line 270. In one embodiment, the second user interface module 259 generates graphical data for providing a user interface that depicts a reward charging service. The second user interface module 259 sends the graphical data to a user device 133 or a dashboard in the vehicle, allowing the user to confirm or reject the reward charging service via the user interface. In other embodiments, the second user interface module 259 is configured to generate any other graphical data for providing user interfaces described herein.

### Storage Device

FIG. 3A is a block diagram illustrating a first storage device 143 according to one embodiment. The first storage device 143 includes schedule data 301, charging profile data 303, social network data 305, user profile data 307 and temperature profile data 309. In some embodiments, the first storage device 143 may include any other data (e.g., forum data describing activities that a user performs on a forum) for providing the functionality described herein.

The schedule data 301 is data describing one or more provisioning schedules. For example, the schedule data 301 includes data describing one or more provisioning start times and/or one or more provisioning completion times for a provisioning schedule. In one embodiment, the schedule data 301 includes data describing charging schedules for charging one or more vehicles. For example, the schedule data 301 includes data describing one or more charging start times and a charging duration for each charging start time associated with a vehicle. In another example, the schedule data 301 includes data describing one or more charging completion times for one or more vehicles.

In one embodiment, the schedule data 301 includes data describing temperature control schedules for controlling temperatures in vehicles. For example, the schedule data 301 includes data describing a start time for beginning the temperature control. In another example, the schedule data 301 includes data describing one or more temperature control completion times for one or more vehicles.

The charging profile data 303 is data describing one or more charging profiles for one or more vehicles. For example, the charging profile data 303 includes data describing a charging completion time, a charging priority and a target power level for a battery at the charging completion time for each charging profile associated with a vehicle.

The social network data 305 is data describing social activities performed by one or more users in a social network. For example, the social network data 305 includes data describing one or more of posts, comments, videos, pictures, activity check-in (e.g., check-in a location, check-in a restaurant, etc.) and indications of approval (e.g., “liked,” “favorite”) for posts and/or comments, etc., published in a social network.

The user profile data 307 is data describing one or more user profiles for one or more users. For example, the user profile data 307 includes one or more of calendar data describing a personal calendar of a user, list data describing a to-do list of the user, event data describing a preferred event list of the user (e.g., an event list including a concert, a sport game, etc.), demographic data (e.g., gender, age, residence, education and/or working experience, etc.) and any other data associated with the user such as personal interests, hobbies, etc.

The temperature profile data 309 is data describing one or more temperature control profiles for one or more vehicles. For example, the temperature profile data 309 includes data describing a temperature control completion time, a temperature control priority and a target temperature, etc.

FIG. 3B is a block diagram illustrating a second storage device 145 according to one embodiment. The second storage device 145 includes battery data 321, GPS data 323, usage data 325, configuration data 327, reward data 329, provisioning data 331 and plan data 333. In other embodiments, the second storage device 145 may include any other data (e.g., sensor data) for providing the functionality described herein.

The battery data 321 is data describing a power level for a battery. For example, the battery data 321 describes that a battery in a vehicle is 90% full.

The GPS data 323 is data generated by a navigation system 127 such as a GPS system. In one embodiment, the GPS data 323 includes a synchronized local time, a current location for a vehicle and route data describing a current route that a vehicle takes (e.g., route duration, a start point and/or an end point of the route, a route path, etc.). In one embodiment, the GPS data 323 includes data describing one or more historic routes that a vehicle has taken.

The usage data 325 is data describing a usage of a vehicle. For example, the usage data 325 includes vehicle usage data describing all the start points and/or end points, start times and/or end times for historic routes, route duration for each route, route paths for the historic routes, etc. In another example, the usage data 325 includes usage data for a mobile computer system 151 such as location data describing historic locations that the mobile computer system 151 has been to.

The configuration data 327 is data describing one or more provisioning configurations. For example, the configuration data 327 includes data for configuring one or more provisioning systems prior to a trip (e.g., parameters for controlling air conditioning system, parameters for controlling vehicle seat temperature, etc.).

In one embodiment, a provisioning configuration includes a temperature control configuration. The configuration data 327 includes temperature control configuration data for configuring the temperature control in a vehicle (e.g., a time parameter indicating a time difference between a start time for a future trip and a temperature control completion time). In another embodiment, a provisioning configuration includes a charging configuration. The configuration data 327 includes charging configuration data. The charging configuration data includes, for example, one or more of charging optimization metrics for optimizing the charging of a vehicle (e.g., minimizing economic cost, maximizing rewards for the charging, satisfying a time constraint and/or charging a vehicle ecofriendly, etc.) and reward participation data describing the reward programs that a vehicle or an owner of the vehicle participates in.

In the depicted embodiment, the configuration data 327 also includes preference data 328. The preference data 328 is data describing one or more provisioning preferences. For example, the preference data 328 includes data describing a provisioning preference specified by a user (e.g., turning on an air conditioning system prior to a trip, charging a battery 100% full prior to a trip, etc.).

In one embodiment, a provisioning preference includes a temperature control preference (e.g., always warming up a driver seat prior to a trip during winter time, turning on the air conditioning system at most 15 minutes prior to a trip, etc.). In another embodiment, a provisioning preference includes a charging preference. For example, the preference data 328 includes data describing one or more of a charging schedule preference (e.g., always to charge a vehicle according to a charging schedule, only to charge a vehicle according to a charging schedule at weekends, always to charge a vehicle at non-peak hours, etc.) and a driver preference (e.g., a first driver prefers to charge the battery with 100% full, a second driver prefers to charge the battery with 80% full, etc.).

The reward data 329 is data describing one or more incentives provided by one or more reward programs and/or reward charging services. For example, the reward data 329 indicates a reduced power rate (e.g., 50% off normal price) for the power usage of charging the vehicle, a high occupancy lane access privilege for a vehicle, free charging for a vehicle when there is surplus power, etc.

The provisioning data 331 is data used for providing provisioning services. For example, the provisioning data 331 includes data (e.g., temperature data, fuel data, battery data, etc.) used for one or more of engine system pre-trip temperature control, pre-trip battery check, fuel check for hybrid vehicles, passenger compartment temperature control, air conditioning system and/or heater control, etc.

The plan data 333 is data describing one or more provisioning plans. For example, the plan data 333 includes one or more of a provisioning completion time, a provisioning priority and a provisioning status for a provisioning plan. In one embodiment, a provisioning plan is one of a charging profile and a temperature control profile, and the plan data 333 includes the charging profile data and the temperature profile data.

### Methods

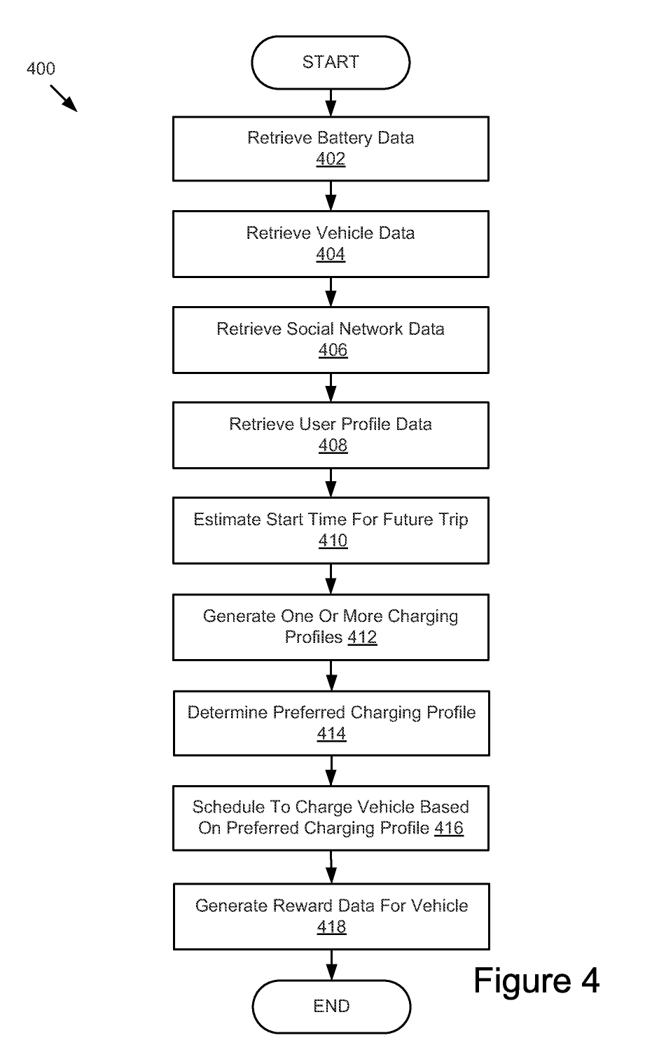

Referring now to FIGS. 4-9B, various embodiments of the method of the specification will be described. FIG. 4 is a flowchart illustrating a method 400 for managing a charging schedule for a vehicle according to one embodiment. In the illustrated embodiment, the retrieval module 203 retrieves 402 battery data describing a current power level of a battery from the second storage 145 via the first communication module 201. The retrieval module 203 retrieves 404 vehicle data from the second storage 145. In one embodiment, the vehicle data includes one or more of location data describing a current location of the vehicle, a local time, charging configuration data and vehicle usage data such as historic route data.

The retrieval module 203 retrieves 406 social network data associated with a user from the social network server 109 via the extraction engine 103. In one embodiment, the retrieval module 203 retrieves the social network data from the first storage 143. The retrieval module 203 retrieves 408 user profile data associated with the user from the user profile server 113 via the extraction engine 103. In one embodiment, the retrieval module 203 retrieves the user profile data from the first storage 143. The retrieval module 203 sends the retrieved data to one or more of the estimation module 205, the profile module 207 and the scheduling module 209.

The estimation module 205 estimates 410 a start time for a future trip based at least in part on one or more of the vehicle data, the social network data and the user profile data. The estimation module 205 sends the estimated start time to the profile module 207. The profile module 207 generates 412 one or more charging profiles for the vehicle. In one embodiment, the profile module 207 determines one or more charging profiles based at least in part on one or more of the estimated start time for the future trip and the charging configuration data for the vehicle. A charging profile includes, for example, a charging completion time, a target power level of the battery, a charging priority, etc.

The profile module 207 determines 414 a preferred charging profile from the one or more charging profiles. In one embodiment, the profile module 207 determines the preferred charging profile from the one or more charging profiles based at least in part on preference data describing one or more charging preferences. In another embodiment, the profile module 207 provides the one or more charging profiles to the user and receives a response regarding the one or more charging profiles from the user. The profile module 207 determines the preferred charging profile based at least in part on the received response.

The scheduling module 209 schedules 416 to charge the vehicle based at least in part on the preferred charging profile. For example, the scheduling module 209 generates a charging schedule including a charging start time based at least in part on the battery data and the preferred charging profile. In one embodiment, the scheduling module 209 generates a charging schedule for the vehicle further based on power grid network data describing power usage in a power grid network. The reward module 175 generates 418 reward data for the vehicle when the vehicle is charged according to the charging schedule.

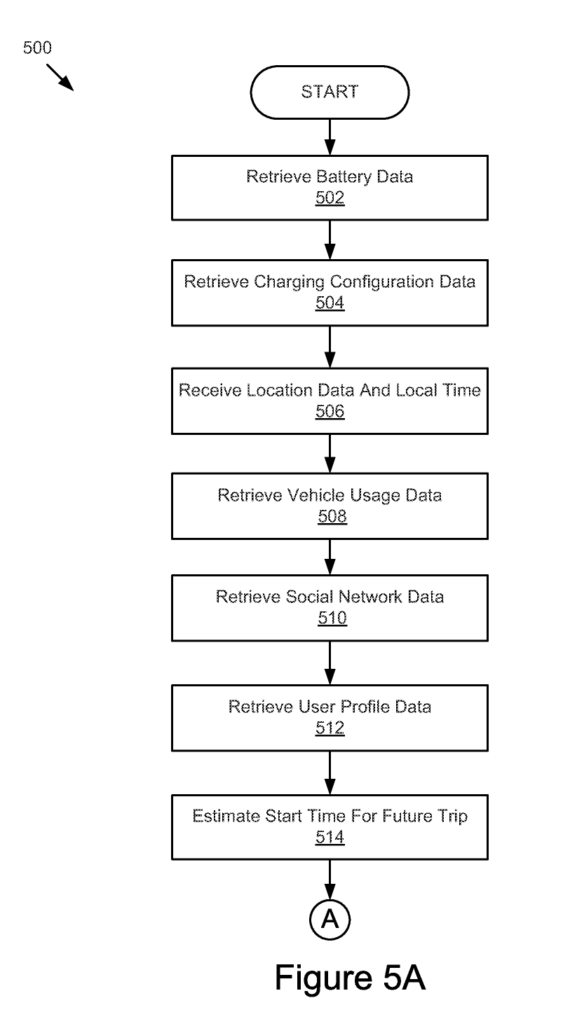

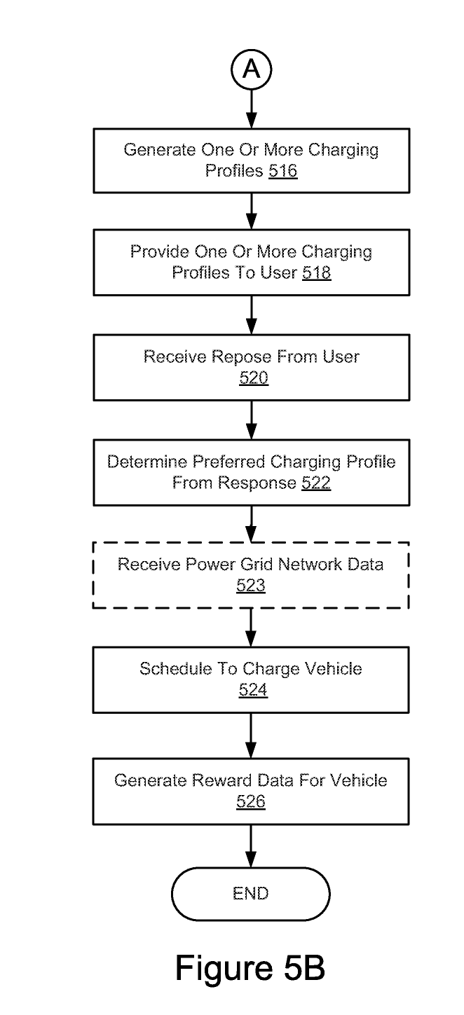

FIGS. 5A and 5B are flowcharts illustrating a method 500 for managing charging schedules for a vehicle according to another embodiment. Referring now to FIG. 5A, the retrieval module 203 retrieves 502 battery data from the second storage 145 via the first communication module 201. The retrieval module 203 retrieves 504 charging configuration data from the second storage 145. The retrieval module 203 receives 506 location data describing a current location of the vehicle and a synchronized local time from a navigation system 127. The retrieval module 203 retrieves 508 vehicle usage data from the second storage 145. The retrieval module 203 retrieves 510 social network data from a social network server 109. The retrieval module 203 retrieves 512 user profile data from a user profile server 113.

The retrieval module 203 sends one or more of the battery data, the charging configuration data, the location data, the local time, the vehicle usage data, the social network data and the user profile data to one or more of the estimation module 205, the profile module 207 and the scheduling module 209. The estimation module 205 estimates 514 a start time for a future trip based at least in part on one or more of the location data, the synchronized local time, the vehicle usage data, the social network data and the user profile data. The estimation module 205 sends the estimated start time for the future trip to the profile module 207.

Referring to FIG. 5B, the profile module 207 generates 516 one or more charging profiles for the vehicle. In one embodiment, the profile module 207 generates one or more charging profiles based at least in part on one or more of the charging configuration data and the start time for the future trip. The profile module 207 provides 518 the one or more charging profiles to the user. For example, the profile module 207 instructs the first user interface module 213 to generate graphical data for providing a user interface to a user. The user interface depicts the one or more charging profiles. The first user interface module 213 sends the graphical data to a user device 133, causing the user device 133 to present the user interface to the user. The user selects a charging profile or modifies a charging profile via the user interface and sends a response including the selected or modified charging profile to the profile module 207.

The profile module 207 receives 520 the response from the user device 133. The profile module 207 determines 522 a preferred charging profile based at least in part on the response. The profile module 207 sends the preferred charging profile to the scheduling module 209. Optionally, the scheduling module 209 receives 523 power grid network data from the energy management system 137. The scheduling module 209 schedules 524 to charge the vehicle based at least in part on the preferred charging profile. In one embodiment, the scheduling module 209 generates a charging schedule for the vehicle based at least in part on one or more of the preferred charging profile and the power grid network data. The reward module 175 generates 526 reward data for the vehicle. For example, the reward module 175 generates reward data for the vehicle when the vehicle is charged according to the charging schedule.

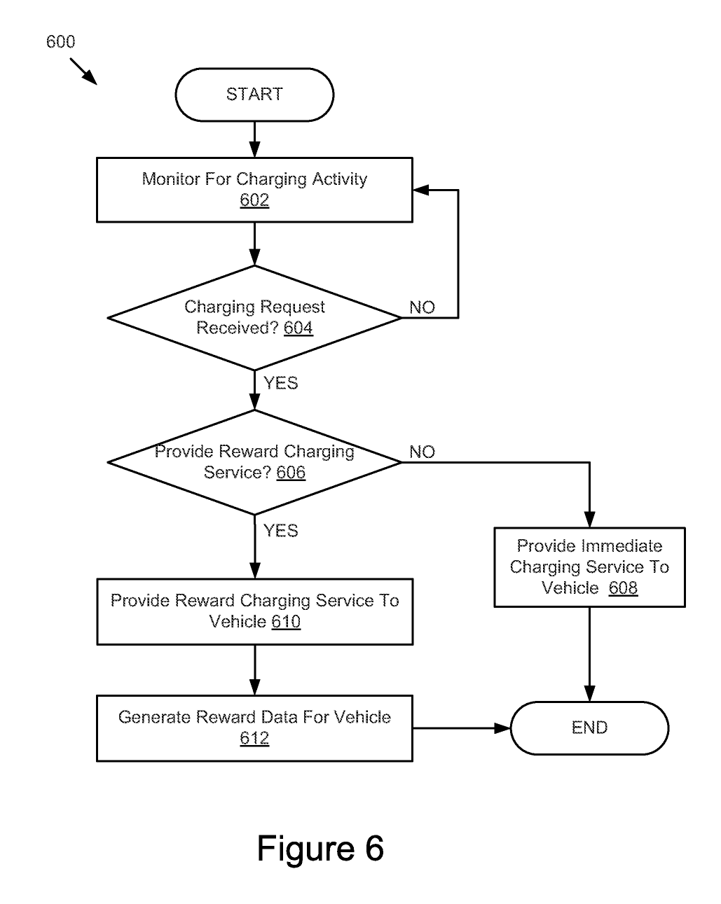

FIG. 6 is a flowchart illustrating a method 600 for charging a vehicle according to one embodiment. In the illustrated embodiment, the monitoring module 253 monitors 602 for any charging activities. The monitoring module 253 determines 604 whether a charging request is received from the vehicle. For example, if the vehicle is connected to a power outlet, the monitoring module 253 receives a charging request from the vehicle indicating that the vehicle is ready to charge. If the monitoring module 253 receives a charging request, the method 600 moves to step 606. Otherwise, the method 600 moves to step 602.

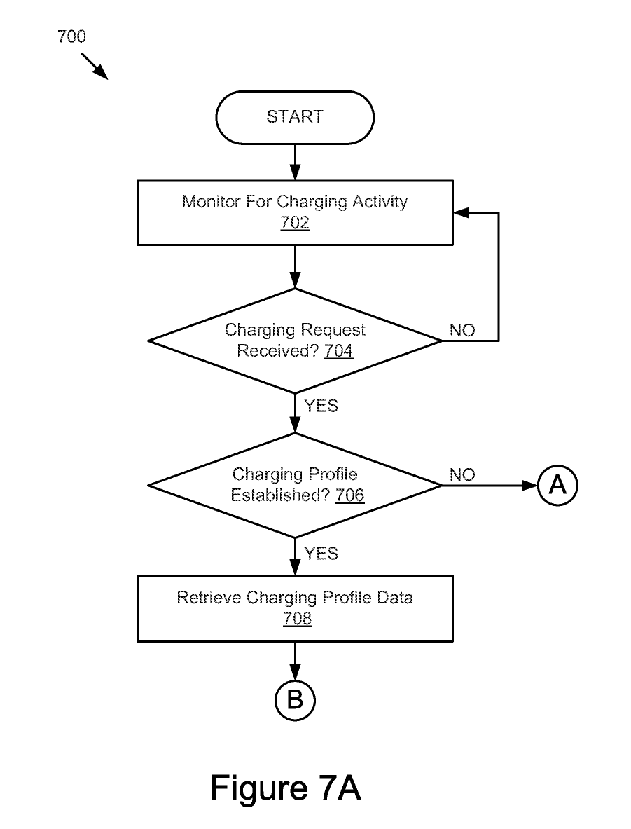

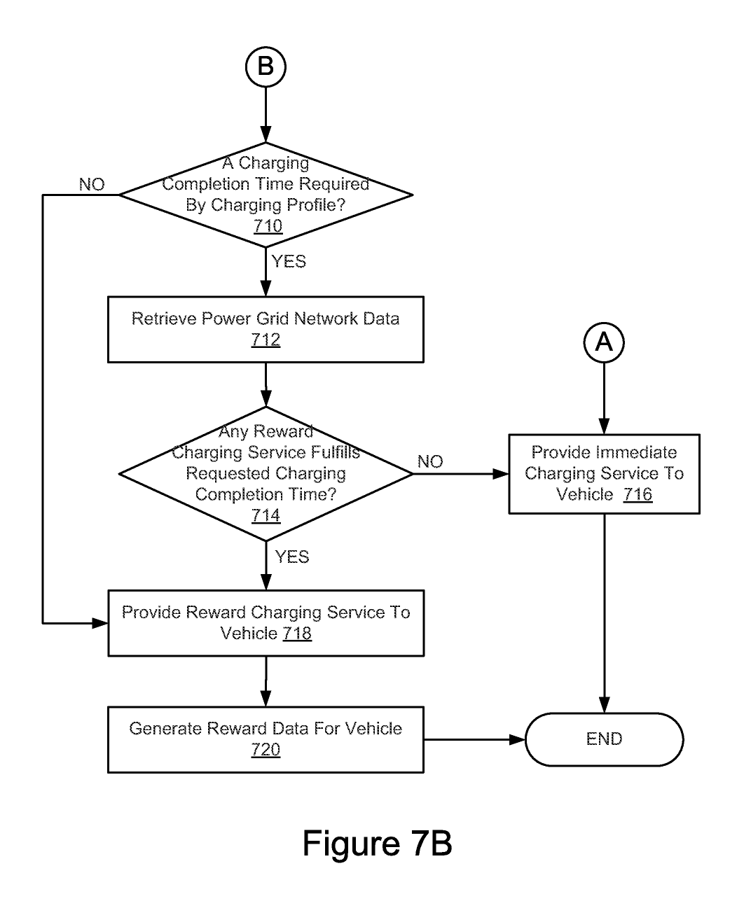

At step 606, the determination module 255 determines 606 whether to provide a reward charging service to the vehicle. For example, the determination module 255 determines whether to provide a reward charging service or an immediate charging service to the vehicle by performing steps 706-714 as described below with reference to FIGS. 7A and 7B. If the determination module 255 determines not to provide any reward charging service to the vehicle, the determination module 255 instructs the reward service module 147 to provide 608 immediate charging service to the vehicle. Otherwise, the determination module 255 instructs the reward service module 147 to provide 610 a reward charging service to the vehicle. The reward module 175 generates 612 reward data for the vehicle according to the reward charging service.

FIGS. 7A and 7B are flowcharts illustrating a method 700 for charging a vehicle according to another embodiment. Referring to FIG. 7A, the monitoring module 253 monitors 702 for charging activities. The monitoring module 253 determines 704 whether any charging request is received from a vehicle. If a charging request is received, the monitoring module 253 sends the charging request to the determination module 255, and the method 700 moves to step 706. Otherwise, the method 700 moves to step 702. At step 706, the determination module 255 determines whether a charging profile is established for the vehicle responsive to receiving the charging request from the monitoring module 253. If the charging profile is not established, the method 700 moves to step 716. Otherwise, the method 700 moves to step 708. At step 708, the determination module 255 retrieves 708 the charging profile for the vehicle from the first storage 143 via the second communication module 251.

Referring to FIG. 7B, the determination module 255 determines 710 whether a charging completion time is required by the charging profile. For example, the determination module 255 determines whether the charging completion time in the charging profile is marked as “none.” If the charging completion time is marked as “none,” no charging completion time is required.

If a charging completion time (e.g., 7:00 AM) is required by the charging profile, the method 700 moves to step 712. Otherwise, the method 700 moves to step 718. Turning to step 712, the determination module 255 retrieves power grid network data describing power usage from the energy management system 137. The determination module 255 determines 714 whether any reward charging service fulfills the requested charging completion time. In one embodiment, the determination module 255 determines whether any reward charging service fulfills the requested charging completion time further based on the power usage described by the power grid network data (e.g., surplus power available, power shortage, power outage, etc.). If there is at least one reward charging service fulfilling the requested charging completion time, the method 700 moves to step 718. Otherwise, the method 700 moves to step 716. At step 716, the reward service module 147 provides an immediate charging service to the vehicle.

Turning to step 718, the reward service module 147 provides a reward charging service to the vehicle. In one embodiment, if a charging completion time is requested by the charging profile, the reward service module 147 provides the reward charging service that fulfills the requested charging completion time to the vehicle. In another embodiment, if no charging completion time is required by the charging profile, the reward service module 147 provides any of the reward charging services to the vehicle such as a reward charging service with maximal rewards to the vehicle. The reward module 175 generates 720 reward data for the vehicle according to the reward charging service.

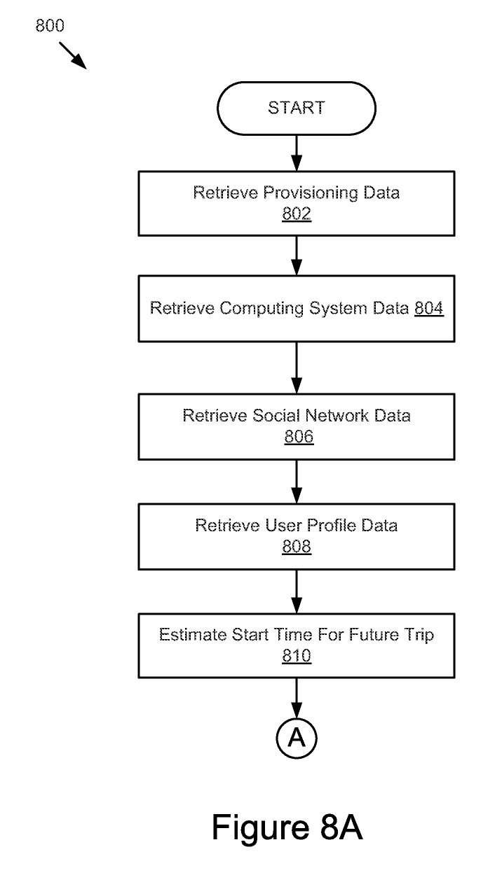

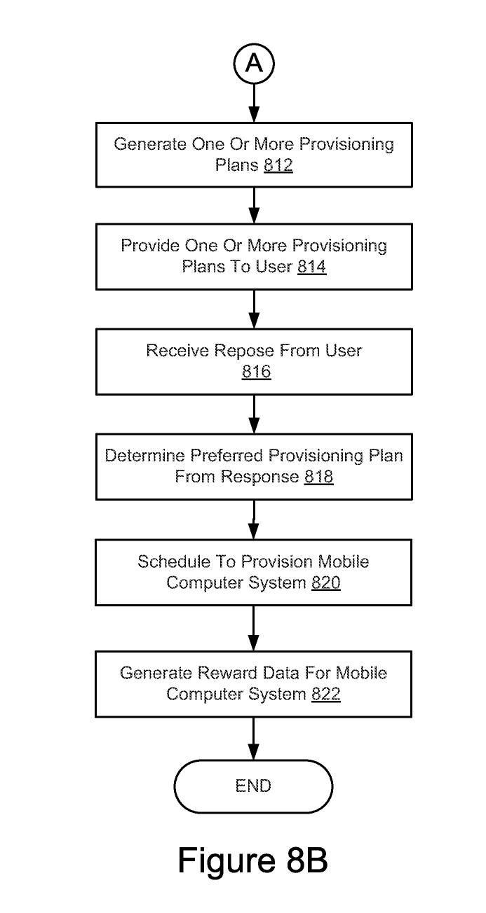

FIGS. 8A and 8B are flowcharts illustrating a method 800 for managing event control schedules such as provisioning schedules for a mobile computer system 151 according to one embodiment. Referring to FIG. 8A, the retrieval module 203 retrieves 802 provisioning data from the second storage 145 via the first communication module 201. The retrieval module 203 retrieves 804 mobile system data associated with the mobile computer system 151 from the second storage 145. The mobile system data includes one or more of provisioning configuration data, vehicle data associated with a vehicle, location data describing a current location of the mobile computer system 151, a synchronized local time and usage data for the mobile computer system 151, etc.

In one embodiment, a local time associated with the mobile computer system 151 and/or the vehicular onboard system 119 is synchronized automatically or manually with a standard time for providing a reliable and accurate time source to the system 100. The local time is therefore referred to as a synchronized local time. For example, a local time is adjusted based on a local time zone and synchronized periodically with the Coordinated Universal Time (UTC) defined by International Telecommunications Union Recommendation (ITU-R TF.460-6) according to the local time zone via a network 105.

The retrieval module 203 retrieves 806 social network data from the social network server 109. The retrieval module 203 retrieves 808 user profile data from the user profile server 113. The retrieval module 203 sends one or more of the provisioning data, the mobile system data, the social network data and the user profile data to one or more of the plan module 206 and the scheduling module 209. The estimation module 205 estimates 810 a start time for a future trip based at least in part on one or more of the mobile system data, the social network data and the user profile data. The estimation module 205 sends the estimated start time for the future trip to the plan module 206.

Referring to FIG. 8B, the plan module 206 generates 812 one or more provisioning plans for providing a provisioning service. For example, the plan module 206 generates one or more provisioning plans based at least in part on one or more of the provisioning configuration data and the start time for the future trip. In one embodiment, the provisioning service includes one or more of charging a vehicle controlled by the mobile computer system 151 and controlling engine temperature for the vehicle prior to the future trip, etc. The one or more provisioning plans include, for example, one or more charging profiles for charging the vehicle and/or temperature control profiles for controlling temperature associated with the vehicle.

The plan module 206 provides 814 the one or more provisioning plans to a user. For example, the plan module 206 instructs the first user interface module 213 to generate graphical data for providing a user interface that depicts the one or more provisioning plans. The first user interface module 213 sends the graphical data to a user device 133, causing the user device 133 to present the user interface to the user. The user selects or modifies a provisioning plan using the user interface and sends a response including the selected or modified provisioning plan to the plan module 206.

The plan module 206 receives 816 the response from the user device 133 and determines 818 a preferred provisioning plan based at least in part on the response. The plan module 206 sends the preferred provisioning plan to the scheduling module 209. The scheduling module 209 schedules 820 to provision the mobile computer system 151 based at least in part on the preferred provisioning plan. For example, the scheduling module 209 generates one or more provisioning schedules for providing one or more provisioning services based at least in part on the preferred provisioning plan. The reward module 175 generates 822 reward data for the mobile computer system 151. For example, the reward module 175 generates reward data for the mobile computer system 151 if a vehicle controlled by the mobile computer system 151 is charged according to a charging schedule included in the preferred provisioning plan.

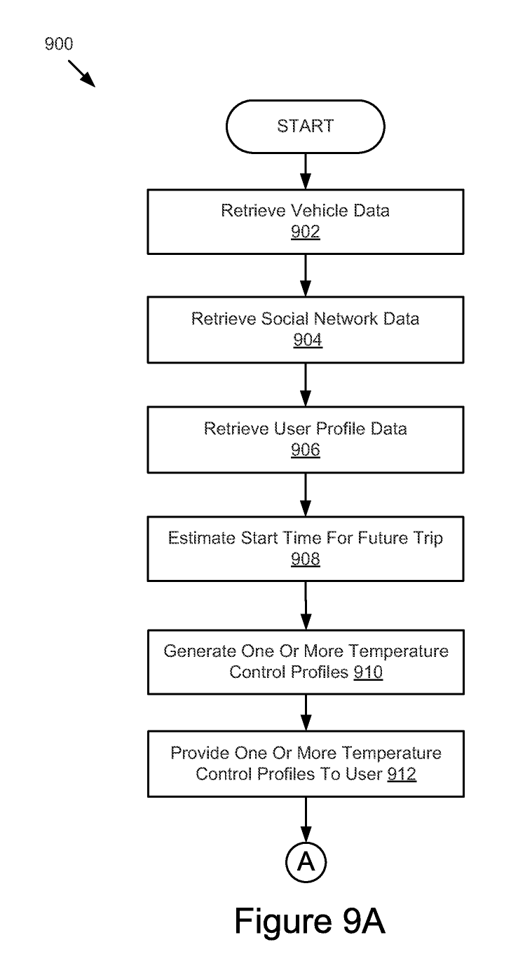

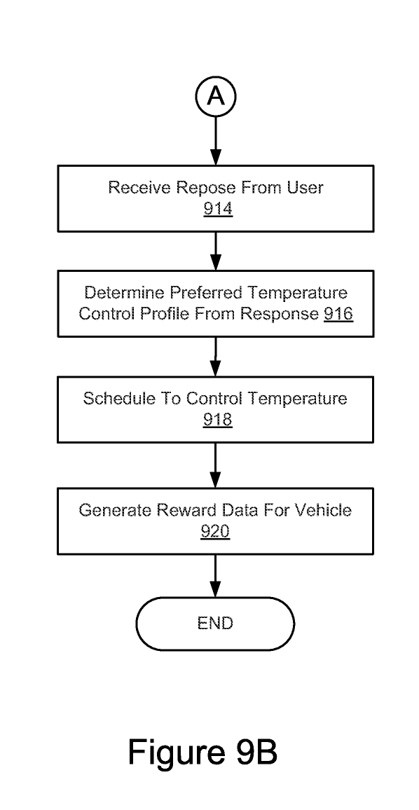

FIGS. 9A and 9B are flowcharts illustrating a method 900 for managing a temperature control schedule according to one embodiment. In one embodiment, a temperature control schedule is one of a heating control schedule and a cooling control schedule. Referring to FIG. 9A, the retrieval module 203 retrieves 902 vehicle data from the second storage 145 via the first communication module 201. In one embodiment, the vehicle data includes one or more of temperature configuration data for the vehicle, location data describing a location of the vehicle, a synchronized local time and vehicle usage data. The retrieval module 203 retrieves 904 social network data from the social network server 109. The retrieval module 203 retrieves 906 user profile data from the user profile server 113.

The retrieval module 203 sends one or more of the vehicle data, the social network data and the user profile data to one or more of the profile module 207 and the scheduling module 209. The estimation module 205 estimates 908 a start time for a future trip based at least in part on one or more of the vehicle data, the social network data and the user profile data. The estimation module 205 sends the estimated start time for the future trip to the profile module 207.

The profile module 207 generates 910 one or more temperature control profiles. For example, the profile module 207 generates one or more temperature control profiles based at least in part on one or more of the start time for the future trip and the temperature configuration data. The profile module 207 provides 912 the one or more temperature control profiles to the user. For example, the profile module 207 instructs the first user interface module 213 to generate graphical data for providing a user interface to the user. The user interface depicts the one or more temperature control profiles. The first user interface module 213 sends the graphical data to a user device 133, causing the user device 133 to present the user interface to the user.

Referring to FIG. 9B, the profile module 207 receives 914 a response regarding the one or more temperature control profiles from the user device 133 and determines 916 a preferred temperature control profile based at least in part on the response. The profile module 207 sends the preferred temperature control profile to the scheduling module 209. The scheduling module 209 schedules 918 to control the temperature associated with the vehicle based at least in part on the preferred temperature control profile. For example, the scheduling module 209 generates one or more temperature control schedules for controlling one or more of an engine temperature, a seat temperature, an air conditioning system, a compartment temperature, a temperature for cooling liquid, etc. The reward module 175 generates 920 reward data for the vehicle. For example, the reward module 175 generates reward data for the vehicle if the vehicle is charged according to a charging schedule generated by the scheduling module 209. In one embodiment, the charging schedule and the temperature control schedule are part of a provisioning schedule.

### Graphical Representations

FIG. 10 is a graphical representation illustrating a user interface 1000 for providing one or more charging profiles to a user according to one embodiment. In some embodiments, other user interfaces similar to the user interface 1000 are generated for providing one or more temperature control profiles and/or provisioning plans to a user. The example user interface 1000 is a user interface displayed on a mobile device such as a smart phone. In other embodiments, the user interface 1000 is modified to be displayed in any other user device 133 such as a laptop, a personal computer, a television, a tablet computer, a dashboard on a vehicle, etc.

In the example, the user interface 1000 includes detail information for a charging profile such as a charging completion time 1002, a charging priority 1008 and a target power level 1010 of a battery at the charging completion time. The user interface 1000 includes one or more “select” buttons and one or more “edit” buttons. For example, a “select” button 1004 allows a user to select the charging completion time 1002 as 5:00 AM. An “edit” button 1006 allows the user to modify the charging completion time 1002. The user interface 1000 also includes a “save” button 1012 for saving the charging profile and a “cancel” button 1014 for canceling the charging profile. If the user selects a button 1016, more charging profiles will be displayed on the user interface 1000.

The foregoing description of the embodiments has been presented for the purposes of illustration and description. It is not intended to be exhaustive or to limit the specification to the precise form disclosed. Many modifications and variations are possible in light of the above teaching. It is intended that the scope of the embodiments be limited not by this detailed description, but rather by the claims of this application. As will be understood by those familiar with the art, the examples may be embodied in other specific forms without departing from the spirit or essential characteristics thereof. Likewise, the particular naming and division of the modules, routines, features, attributes, methodologies and other aspects are not mandatory or significant, and the mechanisms that implement the description or its features may have different names, divisions and/or formats. Furthermore, as will be apparent to one of ordinary skill in the relevant art, the modules, routines, features, attributes, methodologies and other aspects of the specification can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the specification is in no way limited to implementation in any specific programming language, or for any specific operating system or environment. Accordingly, the disclosure is intended to be illustrative, but not limiting, of the scope of the specification, which is set forth in the following claims.

What is claimed is:

1. A computer-implemented method for managing event control schedules for a mobile computer system, the method comprising:
retrieving mobile system data associated with the mobile computer system;
retrieving user profile data associated with a user of the mobile computer system;
estimating a synchronized start time of a future trip for the user based at least in part on one or more of the mobile system data and the user profile data;
generating one or more provisioning plans for the mobile computer system based at least in part on the synchronized start time of the future trip;
determining a preferred provisioning plan from the one or more provisioning plans; and
scheduling to provision the mobile computer system based at least in part on the preferred provisioning plan.

2. The method of claim 1, wherein each of the one or more provisioning plans includes one or more of a provisioning completion time, a provisioning priority and a provisioning status in the mobile computer system at the provisioning completion time.

3. The method of claim 1, further comprising:
generating reward data for the mobile computer system when charging a vehicle controlled by the mobile computer system based at least in part on the preferred provisioning plan.

4. The method of claim 1, wherein determining the preferred provisioning plan from the one or more provisioning plans comprises:
providing the one or more provisioning plans to the user;
receiving a response from the user; and
determining the preferred provisioning plan based at least in part on the received response.

5. The method of claim 1, wherein determining the preferred provisioning plan from the one or more provisioning plans comprises:
extracting preference data describing a provisioning preference for the mobile computer system from the mobile system data; and
determining the preferred provisioning plan from the one or more provisioning plans based at least in part on the preference data.

6. The method of claim 1, further comprising:
retrieving social network data associated with the user; and
determining the synchronized start time of the future trip further based on the social network data.

7. The method of claim 1, wherein the mobile system data includes one or more of provisioning configuration data for the mobile computer system, location data describing a location of the mobile computer system, a local time, data describing a season, weather data and usage data for the mobile computer system.

8. The method of claim 1, wherein the user profile data includes one or more of calendar data describing a personal calendar of the user, list data describing a to-do list of the user, event data describing a preferred event list of the user and demographic data associated with the user.

9. A computer-implemented method for managing a charging schedule, the method comprising:
retrieving vehicle data associated with a vehicle;
retrieving user profile data associated with a user related to the vehicle;
estimating a synchronized start time of a future trip for the user based at least in part on one or more of the vehicle data and the user profile data;
generating one or more charging profiles for the vehicle based at least in part on the synchronized start time of the future trip;
determining a preferred charging profile from the one or more charging profiles; and
scheduling to charge the vehicle based at least in part on the preferred charging profile.

10. The method of claim 9, wherein each of the one or more charging profiles includes one or more of a charging completion time for the vehicle, a charging priority and a target power level of a battery in the vehicle at the charging completion time.

11. The method of claim 9, further comprising:
generating reward data for the vehicle when charging the vehicle based at least in part on the preferred charging profile.

12. The method of claim 9, wherein determining the preferred charging profile from the one or more charging profiles comprises:
providing one or more charging profiles to the user;
receiving a response from the user, and
determining the preferred charging profile based at least in part on the received response.

13. The method of claim 9, wherein determining the preferred charging profile from the one or more charging profiles comprises:
extracting preference data describing a charging preference for the vehicle from the vehicle data; and
determining the preferred charging profile from the one or more charging profiles based at least in part on the preference data.

14. The method of claim 9, further comprising:
retrieving social network data associated with the user; and
determining the synchronized start time of the future trip further based on the social network data.

15. The method of claim 9, wherein the vehicle data includes one or more of charging configuration data for the vehicle, location data describing a location of the vehicle, a local time and vehicle usage data.

16. The method of claim 9, wherein the user profile data includes one or more of calendar data describing a personal calendar of the user, list data describing a to-do list of the user, event data describing a preferred event list and demographic data associated with the user.

17. A computer-implemented method for managing a temperature control schedule, the method comprising:
retrieving vehicle data associated with a vehicle;
retrieving user profile data associated with a user related to the vehicle;
estimating a synchronized start time of a future trip for the user based at least in part on one or more of the vehicle data and the user profile data;
generating one or more temperature control profiles for the vehicle based at least in part on the synchronized start time of the future trip;
determining a preferred temperature control profile from the one or more temperature control profiles; and
scheduling to control a temperature in the vehicle based at least in part on the preferred temperature control profile.

18. The method of claim 17, wherein each of the one or more temperature control profiles includes one or more of a temperature control completion time for the vehicle, a temperature control priority and a target temperature in the vehicle at the temperature control completion time.

19. The method of claim 17, further comprising:
generating reward data for the vehicle when charging the vehicle based at least in part on the temperature control profile.

20. The method of claim 17, wherein determining the preferred temperature control profile from the one or more temperature control profiles comprises:
providing one or more temperature control profiles to the user;
receiving a response from the user; and
determining the preferred temperature control profile based at least in part on the received response.

21. The method of claim 17, wherein determining the preferred temperature control profile from the one or more temperature control profiles comprises:
extracting preference data describing a temperature control preference for the vehicle from the vehicle data; and
determining the preferred temperature control profile from the one or more temperature control profiles based at least in part on the preference data.

22. The method of claim 17, further comprising:
retrieving social network data associated with the user; and
determining the synchronized start time of the future trip further based on the social network data.

23. The method of claim 17, wherein the vehicle data includes one or more of temperature configuration data for the vehicle, location data describing a location of the vehicle, a local time and vehicle usage data.

24. The method of claim 17, wherein the user profile data includes one or more of calendar data describing a personal calendar of the user, list data describing a to-do list of the user, event data describing a preferred event list of the user and demographic data associated with the user.

25. A system for managing event control schedules for a mobile computer system, the system comprising:
a retrieval module for retrieving mobile system data associated with the mobile computer system, the retrieval module retrieving user profile data associated with a user of the mobile computer system;
an estimation module communicatively coupled to the retrieval module, the estimation module estimating a synchronized start time of a future trip for the user based at least in part on one or more of the mobile system data and the user profile data;
a plan module communicatively coupled to the estimation module, the plan module generating one or more provisioning plans for the mobile computer system based at least in part on the synchronized start time of the future trip, the plan module determining a preferred provisioning plan from the one or more provisioning plans; and
a scheduling module communicatively coupled to the plan module, the scheduling module scheduling to provision the mobile computer system based at least in part on the preferred provisioning plan.

26. The system of claim 25, wherein each of the one or more provisioning plans includes one or more of a provisioning completion time, a provisioning priority and a provisioning status in the mobile computer system at the provisioning completion time.

27. The system of claim 25, further comprising:
a reward module communicatively coupled to the plan module and the scheduling module, the reward module generating reward data for the mobile computer system when charging a vehicle controlled by the mobile computer system based at least in part on the preferred provisioning plan.

28. The system of claim 25, wherein the plan module is configured to:
provide the one or more provisioning plans to the user;
receive a response from the user; and
determine the preferred provisioning plan based at least in part on the received response.

29. The system of claim 25, wherein the plan module is configured to:
extract preference data describing a provisioning preference for the mobile computer system from the mobile system data; and
determine the preferred provisioning plan from the one or more provisioning plans based at least in part on the preference data.

30. The system of claim 25, wherein the retrieval module is further configured to retrieve social network data associated with the user, and the estimation module is further configured to determine the synchronized start time of the future trip further based on the social network data.

31. The system of claim 25, wherein the mobile system data includes one or more of provisioning configuration data for the mobile computer system, location data describing a location of the mobile computer system, a local time, data describing a season, weather data and usage data for the mobile computer system.

32. The system of claim 25, wherein the user profile data includes one or more of calendar data describing a personal calendar of the user, list data describing a to-do list of the user, event data describing a preferred event list of the user and demographic data associated with the user.

33. A system for managing a charging schedule, the system comprising:
a retrieval module for retrieving vehicle data associated with a vehicle, the retrieval module retrieving user profile data associated with a user related to the vehicle;
an estimation module communicatively coupled to the retrieval module, the estimation module estimating a synchronized start time of a future trip for the user based at least in part on one or more of the vehicle data and the user profile data;
a profile module communicatively coupled to the estimation module, the profile module generating one or more charging profiles for the vehicle based at least in part on the synchronized start time of the future trip, the profile module determining a preferred charging profile from the one or more charging profiles; and
a scheduling module communicatively coupled to the profile module, the scheduling module scheduling to charge the vehicle based at least in part on the preferred charging profile.

34. The system of claim 33, wherein each of the one or more charging profiles includes one or more of a charging completion time for the vehicle, a charging priority and a target power level of a battery in the vehicle at the charging completion time.

35. The system of claim 33, further comprising:
a reward module communicatively coupled to the profile module and the scheduling module, the reward module generating reward data for the vehicle when charging the vehicle based at least in part on the preferred charging profile.

36. The system of claim 33, wherein the profile module is configured to:
provide one or more charging profiles to the user;
receive a response from the user; and
determine the preferred charging profile based at least in part on the received response.

37. The system of claim 33, wherein the profile module is configured to:
extract preference data describing a charging preference for the vehicle from the vehicle data; and
determine the preferred charging profile from the one or more charging profiles based at least in part on the preference data.

38. The system of claim 33, wherein the retrieval module is further configured to retrieve social network data associated with the user, and the estimation module is further configured to determine the synchronized start time of the future trip further based on the social network data.

39. The system of claim 33, wherein the vehicle data includes one or more of charging configuration data for the vehicle, location data describing a location of the vehicle, a local time and vehicle usage data.

40. The system of claim 33, wherein the user profile data includes one or more of calendar data describing a personal calendar of the user, list data describing a to-do list of the user, event data describing a preferred event list and demographic data associated with the user.

41. A system for managing a temperature control schedule, the system comprising:
a retrieval module for retrieving vehicle data associated with a vehicle, the retrieval module retrieving user profile data associated with a user related to the vehicle;
an estimation module communicatively coupled to the retrieval module, the estimation module estimating a synchronized start time of a future trip for the user based at least in part on one or more of the vehicle data and the user profile data;
a profile module communicatively coupled to the estimation module, the profile module generating one or more temperature control profiles for the vehicle based at least in part on the synchronized start time of the future trip, the profile module determining a preferred temperature control profile from the one or more temperature control profiles; and
a scheduling module communicatively coupled to the profile module, the scheduling module scheduling to control a temperature in the vehicle based at least in part on the preferred temperature control profile.

42. The system of claim 41, wherein each of the one or more temperature control profiles includes one or more of a temperature control completion time for the vehicle, a temperature control priority and a target temperature in the vehicle at the temperature control completion time.

43. The system of claim 41, further comprising:
a reward module communicatively coupled to the profile module and the scheduling module, the reward module generating reward data for the vehicle when charging the vehicle based at least in part on the temperature control profile.

44. The system of claim 41, wherein the profile module is configured to:
provide one or more temperature control profiles to the user;
receive a response from the user; and
determine the preferred temperature control profile based at least in part on the received response.

45. The system of claim 41, wherein the profile module is configured to:
extract preference data describing a temperature control preference for the vehicle from the vehicle data; and
determine the preferred temperature control profile from the one or more temperature control profiles based at least in part on the preference data.

46. The system of claim 41, wherein the retrieval module is further configured to retrieve social network data associated with the user, and the estimation module is further configured to determine the synchronized start time of the future trip further based on the social network data.

47. The system of claim 41, wherein the vehicle data includes one or more of temperature configuration data for the vehicle, location data describing a location of the vehicle, a local time and vehicle usage data.

48. The system of claim 41, wherein the user profile data includes one or more of calendar data describing a personal calendar of the user, list data describing a to-do list of the user, event data describing a preferred event list of the user and demographic data associated with the user.

49. A computer program product comprising a non-transitory computer readable medium encoding instructions that, in response to execution by a computing device, cause the computing device to perform operations comprising:
retrieving mobile system data associated with the mobile computer system;
retrieving user profile data associated with a user of the mobile computer system;
estimating a synchronized start time of a future trip for the user based at least in part on one or more of the mobile system data and the user profile data;
generating one or more provisioning plans for the mobile computer system based at least in part on the synchronized start time of the future trip;
determining a preferred provisioning plan from the one or more provisioning plans; and
scheduling to provision the mobile computer system based at least in part on the preferred provisioning plan.

50. The computer program product of claim 49, wherein each of the one or more provisioning plans includes one or more of a provisioning completion time, a provisioning priority and a provisioning status in the mobile computer system at the provisioning completion time.

51. The computer program product of claim 49, wherein the instructions cause the computing device to perform operations further comprising:
generating reward data for the mobile computer system when charging a vehicle controlled by the mobile computer system based at least in part on the preferred provisioning plan.

52. The computer program product of claim 49, wherein determining the preferred provisioning plan from the one or more provisioning plans comprises:
providing the one or more provisioning plans to the user;
receiving a response from the user; and
determining the preferred provisioning plan based at least in part on the received response.

53. The computer program product of claim 49, wherein determining the preferred provisioning plan from the one or more provisioning plans comprises:
extracting preference data describing a provisioning preference for the mobile computer system from the mobile system data; and
determining the preferred provisioning plan from the one or more provisioning plans based at least in part on the preference data.

54. The computer program product of claim 49, wherein the instructions cause the computing device to perform operations further comprising:
retrieving social network data associated with the user; and
determining the synchronized start time of the future trip further based on the social network data.

55. The computer program product of claim 49, wherein the mobile system data includes one or more of provisioning configuration data for the mobile computer system, location data describing a location of the mobile computer system, a local time, data describing a season, weather data and usage data for the mobile computer system.

56. The computer program product of claim 49, wherein the user profile data includes one or more of calendar data describing a personal calendar of the user, list data describing a to-do list of the user, event data describing a preferred event list of the user and demographic data associated with the user.

57. A computer program product comprising a non-transitory computer readable medium encoding instructions that, in response to execution by a computing device, cause the computing device to perform operations comprising:
retrieving vehicle data associated with a vehicle;
retrieving user profile data associated with a user related to the vehicle;
estimating a synchronized start time of a future trip for the user based at least in part on one or more of the vehicle data and the user profile data;
generating one or more charging profiles for the vehicle based at least in part on the synchronized start time of the future trip;
determining a preferred charging profile from the one or more charging profiles; and
scheduling to charge the vehicle based at least in part on the preferred charging profile.

58. The computer program product of claim 57, wherein each of the one or more charging profiles includes one or more of a charging completion time for the vehicle, a charging priority and a target power level of a battery in the vehicle at the charging completion time.

59. The computer program product of claim 57, wherein the instructions cause the computing device to perform operations further comprising:
generating reward data for the vehicle when charging the vehicle based at least in part on the preferred charging profile.

60. The computer program product of claim 57, wherein determining the preferred charging profile from the one or more charging profiles comprises:
providing one or more charging profiles to the user;
receiving a response from the user; and
determining the preferred charging profile based at least in part on the received response.

61. The computer program product of claim 57, wherein determining the preferred charging profile from the one or more charging profiles comprises:
extracting preference data describing a charging preference for the vehicle from the vehicle data; and
determining the preferred charging profile from the one or more charging profiles based at least in part on the preference data.

62. The computer program product of claim 57, wherein the instructions cause the computing device to perform operations further comprising:
retrieving social network data associated with the user; and
determining the synchronized start time of the future trip further based on the social network data.

63. The computer program product of claim 57, wherein the vehicle data includes one or more of charging configuration data for the vehicle, location data describing a location of the vehicle, a local time and vehicle usage data.

64. The computer program product of claim 57, wherein the user profile data includes one or more of calendar data describing a personal calendar of the user, list data describing a to-do list of the user, event data describing a preferred event list and demographic data associated with the user.

65. A computer program product comprising a non-transitory computer readable medium encoding instructions that, in response to execution by a computing device, cause the computing device to perform operations comprising:
retrieving vehicle data associated with a vehicle;
retrieving user profile data associated with a user related to the vehicle;
estimating a synchronized start time of a future trip for the user based at least in part on one or more of the vehicle data and the user profile data;
generating one or more temperature control profiles for the vehicle based at least in part on the synchronized start time of the future trip;
determining a preferred temperature control profile from the one or more temperature control profiles; and
scheduling to control a temperature in the vehicle based at least in part on the preferred temperature control profile.

66. The computer program product of claim 65, wherein each of the one or more temperature control profiles includes one or more of a temperature control completion time for the vehicle, a temperature control priority and a target temperature in the vehicle at the temperature control completion time.

67. The computer program product of claim 65, wherein the instructions cause the computing device to perform operations further comprising:
generating reward data for the vehicle when charging the vehicle based at least in part on the temperature control profile.

68. The computer program product of claim 65, wherein determining the preferred temperature control profile from the one or more temperature control profiles comprises:
providing one or more temperature control profiles to the user;
receiving a response from the user; and
determining the preferred temperature control profile based at least in part on the received response.

69. The computer program product of claim 65, wherein determining the preferred temperature control profile from the one or more temperature control profiles comprises:
extracting preference data describing a temperature control preference for the vehicle from the vehicle data; and
determining the preferred temperature control profile from the one or more temperature control profiles based at least in part on the preference data.

70. The computer program product of claim 65, wherein the instructions cause the computing device to perform operations further comprising:
retrieving social network data associated with the user; and
determining the synchronized start time of the future trip further based on the social network data.

71. The computer program product of claim 65, wherein the vehicle data includes one or more of temperature configuration data for the vehicle, location data describing a location of the vehicle, a local time and vehicle usage data.

72. The computer program product of claim 65, wherein the user profile data includes one or more of calendar data describing a personal calendar of the user, list data describing a to-do list of the user, event data describing a preferred event list of the user and demographic data associated with the user.
